(19) United States
(12) Patent Application Publication
(10) Pub. No.: US 2024/0276499 A1
(43) Pub. Date: Aug. 15, 2024

(54) UCI AND MULTI-CSI MULTIPLEXING ON PUCCH FOR SBFD

(71) Applicant: QUALCOMM Incorporated, San Diego, CA (US)

(72) Inventors: Abdelrahman Mohamed Ahmed Mohamed IBRAHIM, San Diego, CA (US); Muhammad Sayed Khairy ABDELGHAFFAR, San Jose, CA (US); Ahmed Attia ABOTABL, San Diego, CA (US)

(21) Appl. No.: 18/521,448

(22) Filed: Nov. 28, 2023

Related U.S. Application Data
(60) Provisional application No. 63/484,996, filed on Feb. 14, 2023.

(51) Int. Cl. H04W 72/21; H04B 7/06; H04L 1/1812; H04L 5/14; H04W 72/0453; H04W 72/1273

(52) U.S. Cl. CPC H04W 72/21; H04B 7/0626; H04L 1/1812; H04L 5/14; H04W 72/0453; H04W 72/1273

(57) ABSTRACT

Apparatuses and methods for UCI and multi-CSI multiplexing on PUCCH for SBFD are described. An apparatus is configured to select a PUCCH resource in a FD slot, based on an uplink UCI payload size, for transmission of CSI via the FD slot, and to transmit the UCI in the PUCCH resource. Another apparatus is configured to configure multiple CSI PUCCH resources for a UE, indicate that a will be a FD slot, and receive, in the FD slot, UCI including multiplexed CSI reports in a portion of a PUCCH resource from the set of multiple CSI PUCCH resources. Yet another apparatus is configured to receive a code rate configuration that indicates a maximum coding rate for uplink transmission of information via a PUCCH resource in FD slots, and to transmit a PUCCH in the PUCCH resource of a FD slot with a coding rate based on the maximum coding rate.

### CROSS REFERENCE TO RELATED APPLICATION(S)

This application claims the benefit of and priority to U.S. Provisional Application Ser. No. 63/484,996, entitled “UCI AND MULTI-CSI MULTIPLEXING ON PUCCH FOR SBFD” and filed on Feb. 14, 2023, which is expressly incorporated by reference herein in its entirety.

### TECHNICAL FIELD

The present disclosure relates generally to communication systems, and more particularly, to wireless communications including full duplex resources.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus is configured to select a physical uplink control channel (PUCCH) resource in a full duplex (FD) slot, based on a payload size for uplink control information (UCI), for transmission of at least first channel state information (CSI) via the FD slot. The apparatus is configured to transmit the UCI in the PUCCH resource in the FD slot.

In the aspect, the method includes selecting a PUCCH resource in a FD slot, based on a payload size for UCI, for transmission of at least first CSI via the FD slot. The method also includes transmitting the UCI in the PUCCH resource in the FD slot.

In another aspect of the disclosure, a method, a computer-readable medium, and an apparatus are provided. The apparatus is configured to configure a set of multiple CSI PUCCH resources for a user equipment. The apparatus is also configured to indicate that at least one slot will be a FD slot. The apparatus is further configured to receive, in the FD slot, UCI including multiplexed CSI reports in at least a portion of a PUCCH resource from the set of multiple CSI PUCCH resources.

In the aspect, the method includes configuring a set of multiple CSI PUCCH resources for a user equipment. The method also includes indicating that at least one slot will be a FD slot. The method further includes receiving, in the FD slot, UCI including multiplexed CSI reports in at least a portion of a PUCCH resource from the set of multiple CSI PUCCH resources.

In yet another aspect of the disclosure, a method, a computer-readable medium, and an apparatus are provided. The apparatus is configured to receive a code rate configuration that indicates at least a first maximum coding rate for uplink transmission of first information via a PUCCH resource in FD slots. The apparatus is configured to transmit a first PUCCH in the PUCCH resource of a FD slot with a first coding rate based on the first maximum coding rate.

In the aspect, the method includes to receiving a code rate configuration that indicates at least a first maximum coding rate for uplink transmission of first information via a PUCCH resource in FD slots. The method also includes transmitting a first PUCCH in the PUCCH resource of a FD slot with a first coding rate based on the first maximum coding rate.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4A and FIG. 4B illustrate example diagrams showing full-duplex operation, in accordance with aspects of the present disclosure.

FIG. 4C illustrates examples of full-duplex resources, in accordance with aspects of the present disclosure.

FIG. 4D is a diagram illustrating an example for reporting multiple uplink control information (UCI) types, in accordance with various aspects of the present disclosure.

FIG. 5 is a diagram illustrating examples for multiplexing UCI, in accordance with various aspects of the present disclosure.

FIG. 6 is a diagram illustrating examples for multiplexing UCI, in accordance with various aspects of the present disclosure.

FIG. 7 is a call flow diagram for wireless communications, in accordance with various aspects of the present disclosure.

FIG. 8 is a diagram illustrating examples for sets and allocations of resources, in accordance with various aspects of the present disclosure.

FIG. 9 is a diagram illustrating examples of overlapping resources and resource adaptations, in accordance with various aspects of the present disclosure.

FIG. 10 is a call flow diagram for wireless communications, in accordance with various aspects of the present disclosure.

FIG. 11 is a flowchart of a method of wireless communication, in accordance with various aspects of the present disclosure.

FIG. 12 is a flowchart of a method of wireless communication, in accordance with various aspects of the present disclosure.

FIG. 13 is a flowchart of a method of wireless communication, in accordance with various aspects of the present disclosure.

FIG. 14 is a flowchart of a method of wireless communication, in accordance with various aspects of the present disclosure.

FIG. 15 is a flowchart of a method of wireless communication, in accordance with various aspects of the present disclosure.

FIG. 16 is a diagram illustrating an example of a hardware implementation for an example apparatus and/or network entity.

FIG. 17 is a diagram illustrating an example of a hardware implementation for an example network entity.

### DETAILED DESCRIPTION

Wireless communication networks may enable multiplexing of information for transmission. For instance, a UE may multiplex different instances of UCI in a single UL transmission, e.g., to a base station. For example, a hybrid automatic repeat request (HARQ) acknowledgment (ACK) (HARQ-ACK) and/or a scheduling request (SR) may be multiplexed with one or more instances of channel state information (CSI), one or more instances of CSI may be multiplexed with each other, and/or the like, for reporting by a UE in a physical uplink control channel (PUCCH) resource for an UL transmission.

However, unlike half duplex (HD) resources, in resources for sub-band full duplex (SBFD) operation, a PUCCH resource for a transmission in an SBFD slot may overlap with a guard band or a DL resource(s) in the slot. The UL frequency resources will be different in such SBFD time resources. For example, the uplink sub-bands have less bandwidth to accommodate downlink resources for the full duplex (FD) operations. Uplink resources that are available in HD time periods may not be available in the FD time periods. Overlapping PUCCH resources under such a conflict in a FD time resource may not be available for multiplexing UCI and/or multi-CSI instances. For example, such resources may overlap guard bands and/or DL resources in a FD slot, and even if later PUCCH resources for transmitting multiplexed UCI and multi-CSI instances, this may impact timing, or even ultimate transmission, of UCI/CSI.

Various aspects relate generally to wireless communications utilizing uplink signaling in FD time periods. Some aspects more specifically relate to UCI and multi-CSI multiplexing on PUCCH for SBFD. For instance, aspects may relate to CSI reporting when multiple CSI PUCCH resources are unconfigured, PUCCH resource selection for multi-CSI reporting, enhanced PUCCH resource configurations for SBFD, and/or the like. In some examples, a UE may select a PUCCH resource in a FD slot, based on a UCI payload size, for transmission of CSI(s) via the FD slot, and transmit the UCI in the PUCCH resource in the FD slot. In some examples, a base station may configure a set of multiple CSI PUCCH resources for a UE, indicate that at least one slot will be a FD slot, and receive, in the FD slot, UCI including multiplexed CSI reports in at least a portion of a PUCCH resource from the set of multiple CSI PUCCH resources.

Particular aspects of the subject matter described in this disclosure can be implemented to realize one or more of the following potential advantages. In some examples, by configuring PUCCH resources for FD slots, the described techniques can be used to select a particular PUCCH resource for multiplexing UCI/multi-CSI. In some examples, by selecting a PUCCH resource from an available, non-overlapping FDRA, the described techniques can be used to provide additional transmission options for multiplexing UCI/multi-CSI. In some examples, by dropping overlapping reports or PUCCH resources, the described techniques can be used to adapt and/or prioritize provide UCI/multi-CSI for multiplexing in available resources. In some examples, by adapting overlapping PUCCH resources, the described techniques can be used to provide UCI/multi-CSI for multiplexing via available, non-overlapping resource elements. In some examples, by configuring a maximum coding rate, the described techniques can be used to maintain reliability of PUCCH resources in different slot types (e.g., HD/FD).

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

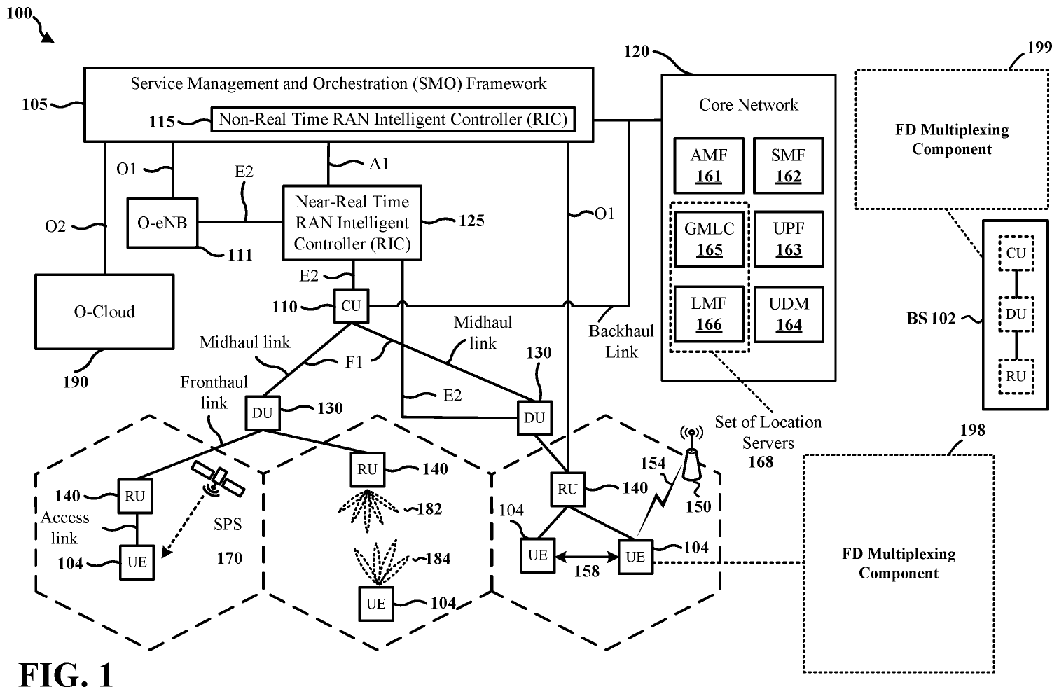

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit—User Plane (CU-UP)), control plane functionality (i.e., Central Unit—Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a FD multiplexing component 198 (“component 198”) that may be configured to select a PUCCH resource in a FD slot, based on a payload size for UCI, for transmission of at least first CSI via the FD slot. The component 198 may be configured to transmit the UCI in the PUCCH resource in the FD slot. The component 198 may be configured to receive a configuration for a set of multiple CSI PUCCH resources, where the UCI includes multiplexed CSI reports, and the PUCCH resource is selected from the set of multiple CSI PUCCH resources. The component 198 may be configured to identify an overlap in time between the first CSI and a second CSI, where the second CSI overlaps with at least one of a downlink or a guard band frequency resources of the FD slot, and to drop transmission of the second CSI based on not having a configuration for multiple CSI PUCCH resources and transmitting the first CSI in the PUCCH resource. The component 198 may be configured to identify an overlap in time between the first CSI and a second CSI, and to drop transmission of the second CSI based on not having a configuration for multiple CSI PUCCH resources and the second CSI having a lower priority than the first CSI. The component 198 may be configured to identify an overlap in time between the first CSI and a second CSI, to compare a sum of the first payload size for the UCI and a second payload size for the first CSI with a resource size of the PUCCH resource, and to drop at least a portion of one of the first CSI and the second CSI based on the sum of the first payload size for the UCI and the second payload size for the first CSI being greater than the resource size of the PUCCH resource. The component 198 may be configured to identify an overlap of an overlapping PUCCH resource with at least one of a downlink (DL) slot or a guard band of the PUCCH, and to adapt an amount of available resources for the PUCCH resource based on a removal of the overlap and a generation of an adapted PUCCH resource, where the removal of the overlap is based on a first number of resource elements (REs) that are non-overlapping with the at least one of a DL slot or the guard band of the PUCCH, and where the generation of the adapted PUCCH resource is based on a second number of resource blocks (RBs) that include the first number of REs, where to transmit the UCI in the PUCCH resource in the FD slot, where the component 198 is configured to transmit the UCI in the adapted PUCCH resource as the PUCCH resource. The component 198 may be configured to receive a code rate configuration that indicates at least a first maximum coding rate for uplink transmission of first information via a PUCCH resource in FD slots. The component 198 may be configured to transmit a first PUCCH in the PUCCH resource of a FD slot with a first coding rate based on the first maximum coding rate. The component 198 may be configured to transmit a second PUCCH in the PUCCH resource of an HD slot with a second coding rate based on the second maximum coding rate, where the code rate configuration also indicates at least a second maximum coding rate for half duplex (HD) slots associated with HD uplink transmission of second information via the PUCCH resource, where the second maximum coding rate is higher than the first maximum coding rate.

In certain aspects, the base station 102 may have a FD multiplexing component 199 (“component 199”) that may be configured to configure a set of multiple CSI PUCCH resources for a user equipment. The component 199 may also be configured to indicate that at least one slot will be a FD slot. The component 199 may be further configured to receive, in the FD slot, UCI including multiplexed CSI reports in at least a portion of a PUCCH resource from the set of multiple CSI PUCCH resources.

That is, aspects provide for UCI and multi-CSI multiplexing on PUCCH for SBFD that enables configurations of PUCCH resources in SBFD UL transmissions, enables handling of overlaps for PUCCH resources in SBFD with guard bands and DL sub-bands, and provides additional transmission options for multiplexing UCI/multi-CSI. Additionally, PUCCH resources may be adapted to conform to the UL sub-band, multiplexed UCI and multi-CSI may be prioritized for transmissions in available resources, and configured maximum coding rates provide for maintained reliability of PUCCH resources in HD/FD transmissions.

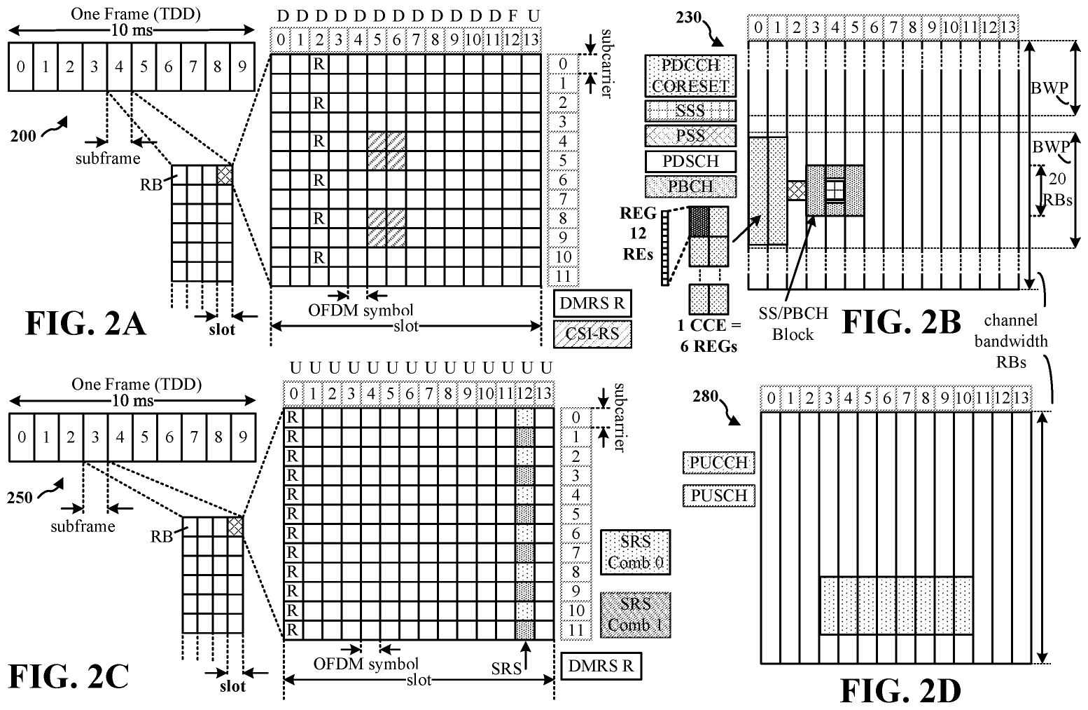

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15 [kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2 slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 s. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

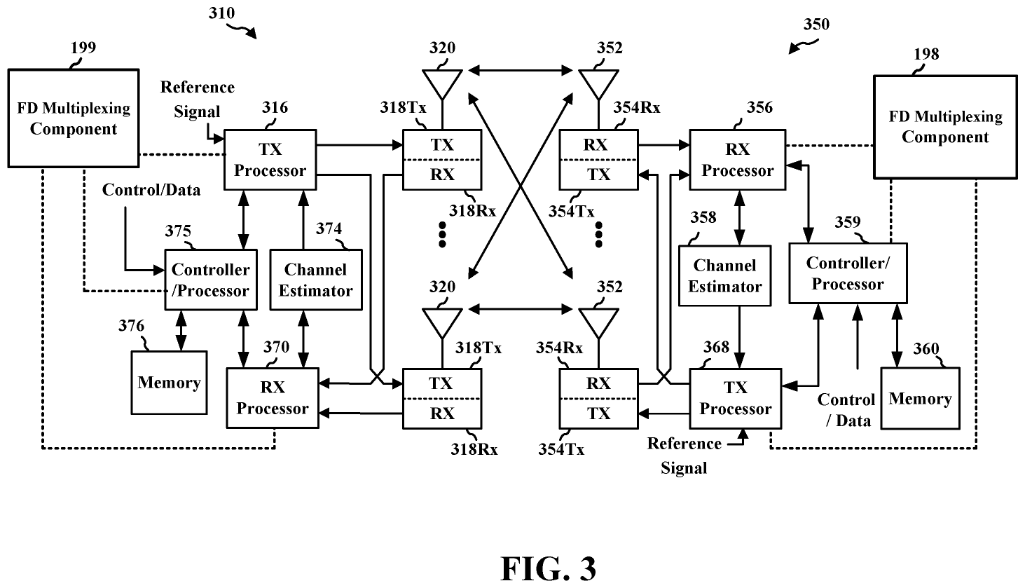

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the component 198 of FIG. 1. At least one of the TX processor 316, the RX processor 370, and the controller/processor 375 may be configured to perform aspects in connection with the component 199 of FIG. 1.

Different instances of UCI may be multiplexed in a single UL transmission from a UE, e.g., to a base station. As examples, a HARQ-ACK and/or a SR may be multiplexed with one or more instances of CSI, one or more instances of CSI may be multiplexed with each other, and/or the like, for reporting by a UE in a PUCCH resource for an UL transmission. However, unlike HD resources, in resources for SBFD operations, such as an SBFD slot, a PUCCH resource may overlap with a guard band or a DL frequency resource(s) in the slot. That is, UL sub-bands may have less bandwidth in which to accommodate downlink and/or guard band resources for FD operations, e.g., such that slots for FD operation have reduced uplink resources than slots for HD operations. PUCCH resources that overlap with downlink frequency resources for a FD mode may not be available for multiplexing UCI and/or multi-CSI instances. While later HD slots may have the PUCCH available PUCCH, such resources may also overlap guard bands and/or DL resources, and even if later PUCCH resources are capable of transmitting multiplexed UCI and multi-CSI instances, this may impact timing, or even ultimate transmission, of UCI/CSI.

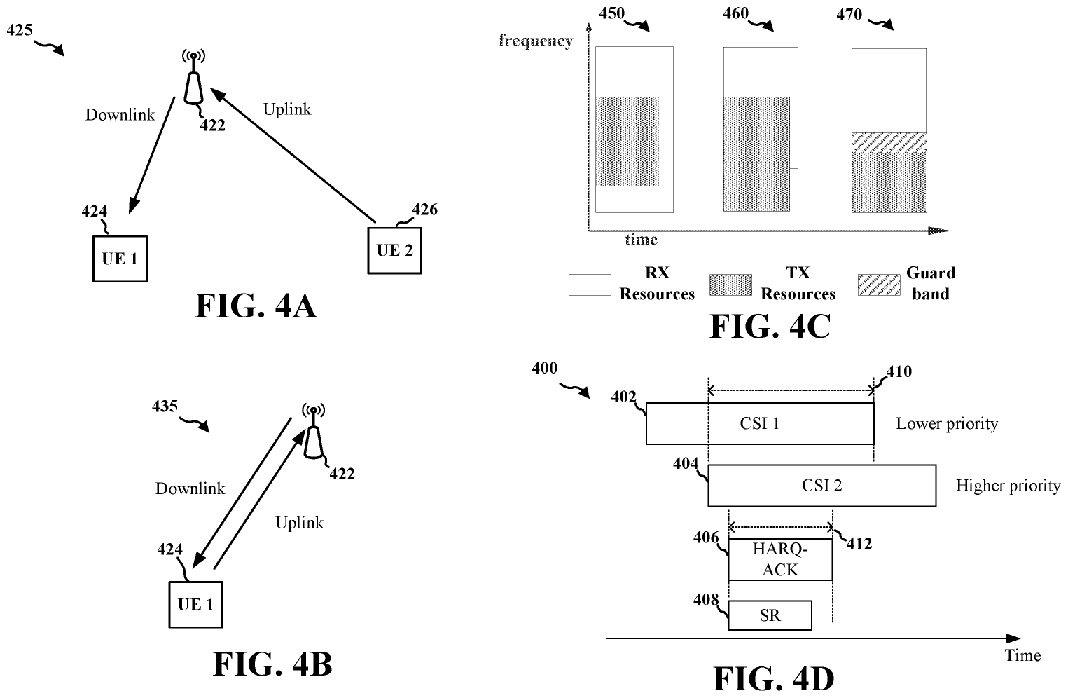

FIG. 4A illustrates a diagram 425 showing an example of FD operation of a base station 422 that transmits to the UE 424 and receives from the UE 426 simultaneously, e.g., overlapping at least partially in time. The UEs, e.g., the UE 424 and the UE 426, may have an HD operation, e.g., with the UE 424 receiving downlink communication, and the UE 426 transmitting uplink communication. FIG. 4B illustrates an example diagram 435 in which the base station 422 and the UE 424 may both be engaged in FD communication. In other aspects, the UE 424 may use a FD operation with multiple devices, such as multiple base stations, multiple UEs, or a base station and at least one other UE.

Full duplex communication may be in a same frequency band. The uplink and downlink communication may be in different frequency subbands, in the same frequency subband, or in partially overlapping frequency subbands. FIG. 4C illustrates a first example 450 and a second example 460 of in-band full-duplex (IBFD) resources and a third example 470 of sub-band full-duplex resources. In IBFD, signals may be transmitted and received in overlapping times and overlapping in frequency. As shown in the first example 450, a time and a frequency allocation of transmission resources may fully overlap with a time and a frequency allocation of reception resources. In the second example 460, a time and a frequency allocation of transmission resources may partially overlap with a time and a frequency of allocation of reception resources.

IBFD is in contrast to sub-band FDD, where transmission and reception resources may overlap in time using different frequencies, as shown in the third example 470. In the third example 470, the UL, the transmission resources may be separated from the reception resources by a guard band. The guard band may be frequency resources, or a gap in frequency resources, provided between the transmission resources and the reception resources. Separating the transmission frequency resources and the reception frequency resources with a guard band may help to reduce self-interference. Transmission resources and a reception resources that are immediately adjacent to each other may be considered as having a guard band width of 0. As an output signal from a wireless device may extend outside the transmission resources, the guard band may reduce interference experienced by the wireless device. Sub-band FDD may also be referred to as “flexible duplex”.

If the full-duplex operation is for a UE or a device implementing UE functionality, the transmission resources may correspond to uplink resources, and the reception resources may correspond to downlink resources. Alternatively, if the full-duplex operation is for a base station or a device implementing base station functionality, the transmission resources may correspond to downlink resources, and the reception resources may correspond to uplink resources.

The handling of UCI multiplexing for semi-persistent scheduling (SPS) HARQ, for instance, may be based on whether there is an overlap between multiple PUCCH resources and if a multi-CSI PUCCH resource list (“multi-CSI-PUCCH-ResourceList”) is configured or not for a UE. For example, if a UE is configured with multiple PUCCH resources in a slot to transmit CSI reports, and if the UE is not provided with the multi-CSI-PUCCH-ResourceList configuration or if PUCCH resources for transmissions of CSI reports do not overlap in the slot, the UE may determine a first resource corresponding to a CSI report with the highest priority. Additionally, the UE may use a second resource (e.g., two resources are non-overlapping and one is format 2 and the other is format 3/4). If the UE is provided with the multi-CSI-PUCCH-ResourceList configuration and if any of the multiple PUCCH resources overlap, the UE may multiplex all CSI reports in a resource from the resources provided by multi-CSI-PUCCH-ResourceList.

Regarding HD and non-duplexed, or non-full-duplex, operations, for a transmission occasion of a single CSI report, a PUCCH resource may be provided by a PUCCH CSI resource list (which may be referred to as a “pucch-CSI-ResourceList”) that is configured for the UE by the network. The pucch-CSI-ResourceList may be configured in a periodic/semi-periodic CSI report configuration. For a transmission occasion of multiple CSI reports, corresponding PUCCH resources may be provided by the multi-CSI-PUCCH-ResourceList configuration, which may be provided to the UE by the network in a PUCCH configuration, which may be referred to as a “PUCCH-Config.” If a UE is provided a single PUCCH resource set for transmission of HARQ-ACK information in response to a PDSCH reception scheduled by a DCI format or in response to a SPS PDSCH release, the UE may not expect to be provided with “simultaneousHARQ-ACK-CSI.” A UE may be configured for a maximum coding rate by “maxCodeRate,” (e.g., a code rate for multiplexing HARQ-ACK, SR, and CSI report(s) in a PUCCH transmission using PUCCH format 2, PUCCH format 3, or PUCCH format 4). If a UE transmits CSI reports using PUCCH format 2, the UE transmits wideband CSI for each CSI report

Aspects described herein for UCI and multi-CSI multiplexing on PUCCH for SBFD may provide enhancements to UCI reporting and PUCCH resource configurations. In aspects, a UE may select a PUCCH resource in a FD slot, based on a UCI payload size, for transmission of CSI(s) via the FD slot, and transmit the UCI in the PUCCH resource in the FD slot. In aspects, a base station may configure a set of multiple CSI PUCCH resources for a UE, indicate that at least one slot will be a FD slot, and receive, in the FD slot, UCI including multiplexed CSI reports in at least a portion of a PUCCH resource from the set of multiple CSI PUCCH resources. Aspects improve CSI reporting when multiple CSI PUCCH resources are unconfigured and improve PUCCH resource selection for multi-CSI reporting. Aspects also improve transmission options for multiplexing UCI/multi-CSI, allow adaptation and/or prioritization to provide UCI/multi-CSI for multiplexing in available resources, provide UCI/multi-CSI for multiplexing via available, non-overlapping resource elements allocated via FDRA, and configure maximum coding rates to maintain reliability of PUCCH resources in different slot types (e.g., HD/FD).

While various aspects may be described in the context of UCI and multi-CSI multiplexing on PUCCH for SBFD for descriptive and illustrative purposes, aspects are not so limited and are applicable to other types of resources, traffic, and/or data, as would be understood by persons of skill in the relevant art(s) having the benefit of this disclosure.

FIG. 4D is a diagram 400 illustrating an example for reporting multiple UCI types, in various aspects. Diagram 400 shows an example UE procedure with respect to time for multiplexing a first CSI report 402, a second CSI report 404, a HARQ-ACK 406, and a SR occasion 408. If a UE is not provided with the multi-CSI-PUCCH-ResourceList configuration, and a resource for a PUCCH with HARQ-ACK 406 for SPS PDSCH reception and/or a resource for a PUCCH associated with the SR occasion 408 overlap in time (e.g., an overlap 410) with two resources for respective PUCCHs with two CSI reports (the first CSI report 402, the second CSI report 404), and there is no resource for a PUCCH with the HARQ-ACK 406 in response to a DCI that overlaps in time (e.g., an overlap 412) with any of the previous resources, and the UE attempts to determine a single PUCCH resource from the HARQ-ACK 406 and/or the SR occasion 408 resource and the two PUCCH resources with the first CSI report 402 and the second CSI report 404, then the UE may multiplex the HARQ-ACK 406 information and/or the SR occasion 408 in the resource for the PUCCH with the CSI report having the higher priority (the first CSI report 402), and may not transmit the PUCCH with the CSI report having the lower priority (the second CSI report 404).

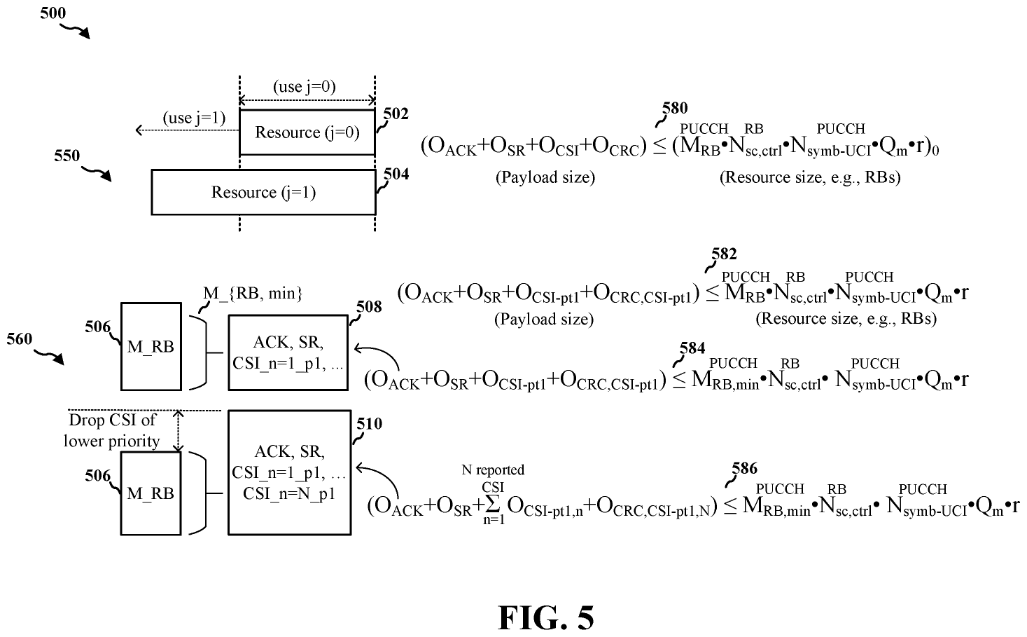

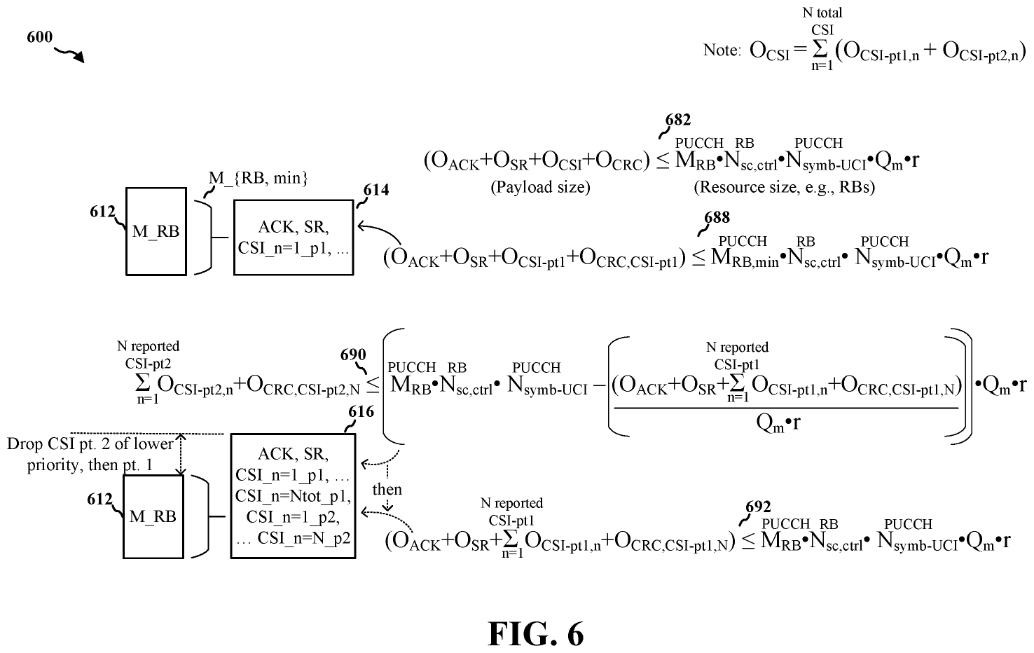

FIGS. 5, 6 are now described for examples of multiplexing UCI. For instance, there may be different cases for multiplexing HARQ-ACK, SR, and CSI in a PUCCH. FIG. 5 shows a case for multiplexing CSI and zero or more HARQ-ACKs/SRs, and a case for CSI (format 2) and wideband CSI (format 3/4) with a HARQ-ACK and a SR; FIG. 6 shows a case for multiplexing sub-band CSI (format 3/4).

FIG. 5 is a diagram 500 illustrating examples for multiplexing UCI, in various aspects. In diagram 500, a configuration 550 includes a resource 502 and a resource 504. Also shown is a comparison 580 of a payload size for UCI instances/occasions against a resource size, in RBs (e.g., as associated with the resource 502 and/or the resource 504). For the case of multiplexing CSI and zero or more HARQ-ACKs/SRs, shown as the configuration 550, a UE may have one or more CSI reports and zero or more HARQ-ACK/SR information bits to transmit in a PUCCH, where the HARQ-ACK, if any, is in response to a SPS PDSCH. If any of the CSI reports are overlapping and the UE is provided by multi-CSI-PUCCH-ResourceList of resources (J=1,2) PUCCH resources in a slot (e.g., resource 502 for J=1, and resource 504 for J=2), for PUCCH format 2/3/4, where the resources are indexed according to an ascending order for the product of number of corresponding REs, modulation order, and configured code rate, the UE may be configured to choose resource 502 for index ‘j=0’ or resource 504 for index ‘j=1’ based on the CSI payload size.

That is, the UE may be configured to use the index j=0, e.g., resource 502, when the comparison 580 is true (e.g., the payload size is less than or equal to the resource size of resource 502), and if not use the index j=1 if the payload size is less than or equal to the resource size of resource 504 per the comparison 580. If not, e.g., the payload size is greater than payload of the resource 504, then the UE may select subset of CSI report(s) for transmission together with HARQ-ACK and SR, when any, in ascending priority value. Otherwise, the UE may transmit the bits of the payload (shown by the payload size in the comparison 580: O_{ACK}+O_{SR}+O_{CSI}+O_{CRC}) in a PUCCH resource provided by the pucch-CSI-ResourceList configuration.

In diagram 500, a configuration 560 includes maximum RBs 506 (a maximum configured number of RBs for a PUCCH format), a payload 508, and a payload 510. Also shown is a comparison 582 of a payload size for UCI instances/occasions against a size of the maximum RBs 506, a comparison 584 of a payload size for UCI instances/occasions against a size of the minimum RBs (e.g., M_{RB, min}) of the maximum RBs 506 to handle the payload size for UCI instances/occasions, and a comparison 586 of a payload size for a set or subset of the UCI instances/occasions against a size of the maximum RBs 506 to handle the payload size for the set/subset of the UCI instances/occasions. For the comparison 586, in the illustrated example, the ‘part 1’ CSI report may refer to a CSI report with wideband CSI and with, or without, sub-band CSI. In diagram 500 of FIG. 5, for the case of multiplexing CSI (format 2) and wideband CSI (format 3/4) with a HARQ-ACK and a SR, shown as the configuration 560, a UE may have a HARQ-ACK, a SR and wideband or sub-band CSI reports using PUCCH format 2, or the UE may have a HARQ-ACK, a SR and wideband CSI reports using PUCCH format 3/4. In such cases, where the UE determines the PUCCH resource using a PUCCH resource indicator field (PRI) in a last of a number of DCI formats with a PDSCH-to-HARQ_feedback timing indicator field, if present, indicating a same slot for the PUCCH transmission, from a PUCCH resource set provided to the UE for HARQ-ACK transmission.

For instance, if the size of the payload 508 is less than or equal to the size of the maximum RBs 506, based on comparison 582, then a UE may utilize the comparison 584 of the payload size for the payload 508 against the size of the minimum RBs of the maximum RBs 506 to handle the payload size for the payload 508. As another example, in the context of the payload 510, which is illustrated to show priorities of a set of CSI reports, when the comparison 582 is not true for the size of the payload 510, the UE may select a subset of the CSI reports in the payload 510 with the HARQ-ACK and SR, based on the comparison 586. That is, the CSI reports that form the subset may be selected based on having a higher priority(ies) than those not selected for the subset, and CSI reports may be dropped from the set of CSI reports, e.g., may not be included in the subset, until the comparison 586 is satisfied.

FIG. 6 is a diagram 600 illustrating examples for multiplexing UCI, in various aspects. Diagram 600 may be a continuing aspect of diagram 500 in FIG. 5, and shows the case of multiplexing sub-band CSI (format 3/4). Diagram 600 includes maximum RBs 612 (a maximum configured number of RBs for a PUCCH format), a payload 614, and a payload 616. Also shown is a comparison 682 of a payload size for UCI instances/occasions against a size of the maximum RBs 612, a comparison 688 of a payload size for UCI instances/occasions against a size of the minimum RBs (e.g., M_{RB, min}) of the maximum RBs 612 to handle the payload size for UCI instances/occasions, a comparison 690 of a payload size for a set or subset of the UCI instances/occasions with a dropped portion of ‘part 2’ CSI reports, then a dropped portion of ‘part 1’ reports based on payload size) against a size of the maximum RBs 612 to handle the payload size for the set/subset of the UCI instances/occasions, a comparison 692 of a payload size for a set or subset of the UCI instances/occasions with all ‘part 2’ CSI reports dropped, then a dropped portion of ‘part 1’ CSI reports based on payload size to form a subset of the ‘part 1’ CSI reports) against a size of the maximum RBs 612 to handle the payload size for the set/subset of the UCI instances/occasions. The UE may have a HARQ-ACK, a SR and sub-band CSI reports using PUCCH format 3/4. In such a case, the UE may determine the PUCCH resource using PRI in a last of a number of DCI formats with a PDSCH-to-HARQ_feedback timing indicator field indicating a same slot for the PUCCH transmission from a PUCCH resource set provided to the UE for HARQ-ACK transmission.

For instance, if the size of the payload 614 is less than or equal to the size of the maximum RBs 612, based on comparison 682, then a UE may utilize the comparison 688 of the payload size for the payload 614 against the size of the minimum RBs of the maximum RBs 612 to handle the payload size for the payload 614. As another example, in the context of the payload 616, which is illustrated to show priorities of a set of CSI reports for both ‘part 1’ CSI reports and ‘part 2’ CSI reports, when the comparison 682 is not true for the size of the payload 616, the UE may select a subset of the CSI reports in the payload 616 with the HARQ-ACK and SR, based on the comparison 690. That is, the CSI reports that form the subset may be selected based on dropping ‘part 2’ CSI reports (e.g., higher priority CSI reports are kept and lower priority CSI reports are dropped first, in ascending priority order) and on the payload size of the payload 616 as drops occur, such that the comparison 690 is satisfied. In scenarios where the comparison 690 is not satisfied having dropped all ‘part 2’ CSI reports, ‘part 1’ CSI reports may then be dropped from the set of CSI reports (e.g., with lower priority CSI reports dropped first, in ascending priority order), until the comparison 692 is satisfied.

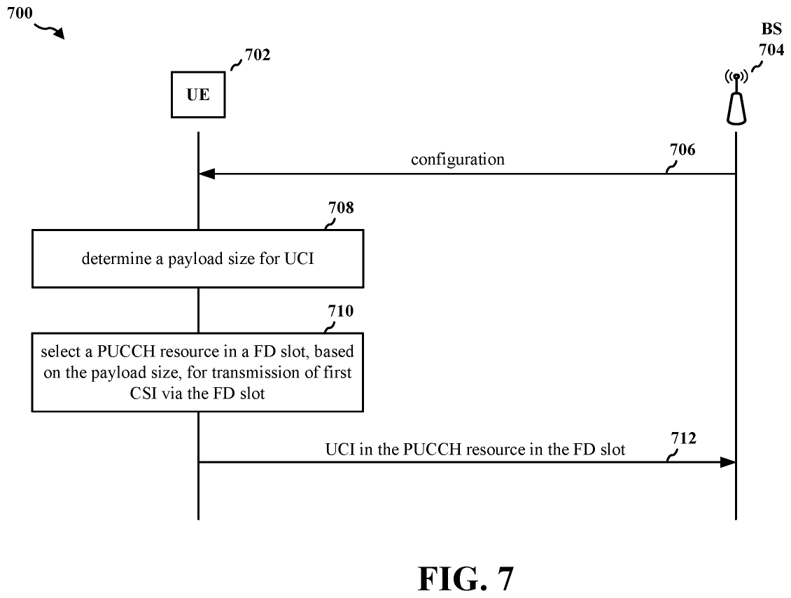

FIG. 7 is a call flow diagram 700 for wireless communications, in various aspects. Call flow diagram 700 illustrates UCI and multi-CSI multiplexing on PUCCH for SBFD by a UE (e.g., a UE 702) that may communicate with a network node (a base station 704, such as a gNB or other type of base station, by way of example, as shown). Aspects described for the base station 704 may be performed by the base station in aggregated form and/or by one or more components of the base station 704 in disaggregated form. Additionally, or alternatively, the aspects may be performed by the UE 702 autonomously, in addition to, and/or in lieu of, operations of the base station 704.

In the illustrated aspect, the UE 702 may be configured to receive a configuration 706 that is transmitted/provided by the base station 704. That is, the base station 704 may be configured to provide, and the UE 702 may be configured to receive a configuration for a set of multiple CSI PUCCH resources. In some aspects, the configuration may be provided in RRC signaling. In aspects, the UE 702 may select UCI 712 to transmit to the base station 704 via a PUCCH resource, e.g., based on the configuration 706. As an example, the configuration may include a resource list for multiple CSI PUCCH resources, e.g., which may be referred to as a multi-CSI-PUCCH-ResourceList.

The UCI 712 may include multiplexed CSI reports, and the PUCCH resource may be selected from the set of multiple CSI PUCCH resources, e.g., a multi-CSI-PUCCH-ResourceList. The UCI 712 may further include, in some aspects, at least one of a HARQ-ACK information for a dynamic PDSCH, a SPS PDSCH, or a SR. The configuration 706 may be comprised in a PUCCH configuration for SBFD communication, e.g., an SBFD-specific PUCCH configuration, in some aspects. In other aspects, the configuration 706 may be comprised in a PUCCH configuration for FD and HD communications and may include separate resource lists for multi-CSI-PUCCH resources in FD slots and in HD slots. In such other aspects, the configuration 706 may include a first configuration of resources associated with HD operation (e.g., which may be referred to as a multi-CSI-PUCCH-ResourceList), and a second configuration of resources associated with FD operation, e.g., which may be referred to as a multi-CSI-PUCCH-ResourceList-SBFD. In aspects, the configuration 706 may include a single resource list, e.g., a single a multi-CSI-PUCCH-ResourceList, that includes a first subset of resources (e.g., a first set of indexes) associated with FD operation and a second subset of resources (e.g., a second set of indexes) associated with HD operation.

The UE 702 may be configured to determine (at 708) a payload size for the UCI 712. The UE 702 may be configured to determine (at 708) the payload size based on one or more of a number of bits associated with the HARQ-ACK information for the dynamic PDSCH of the UCI 712, a number of bits associated with the SPS PDSCH of the UCI 712, a number of bits associated with the SR of the UCI 712, a number of bits associated with a CSI of the UCI 712, a number of cyclic redundancy check (CRC) bits of the UCI 712, and/or the like.

The UE 702 may be configured to select (at 710) a PUCCH resource in a FD slot, based on the payload size (e.g., determined at 708), for transmission of at least a first CSI via the FD slot. In one aspect, where the configuration 706 is comprised in a PUCCH configuration for FD and HD communication and includes a first configuration of resources associated with HD operations and a second configuration of resources associated with FD operations, the UE 702 may be configured to select the selected set of PUCCH resources based on the FD slot having a FD slot type associated with the FD operation. In aspects, where the configuration 706 includes a first subset of resources associated with FD operation and a second subset of resources associated with HD operation, the PUCCH resource may be selected from the first subset of resources associated with the FD operation. The UE 702 may be configured to select (at 710) the PUCCH resource in the FD slot from the set of multiple CSI PUCCH resources after removal of frequency resources from a FDRA that overlap with downlink or guard band frequency resources in the FD slot. The UE 702 may be configured to select (at 710) the PUCCH resource in the FD slot from the set of multiple CSI PUCCH resources that are non-overlapping with downlink or guard band frequency resources in the FD slot. The UE 702 may then be configured to transmit the UCI 712 in the PUCCH resource (e.g., selected at 710) in the FD slot.

In some aspects, the UE may not receive a configuration of PUCCH resources for multiple CSI, e.g., multi-CSI-PUCCH-ResourceList, and may handle the overlap of CSI differently.

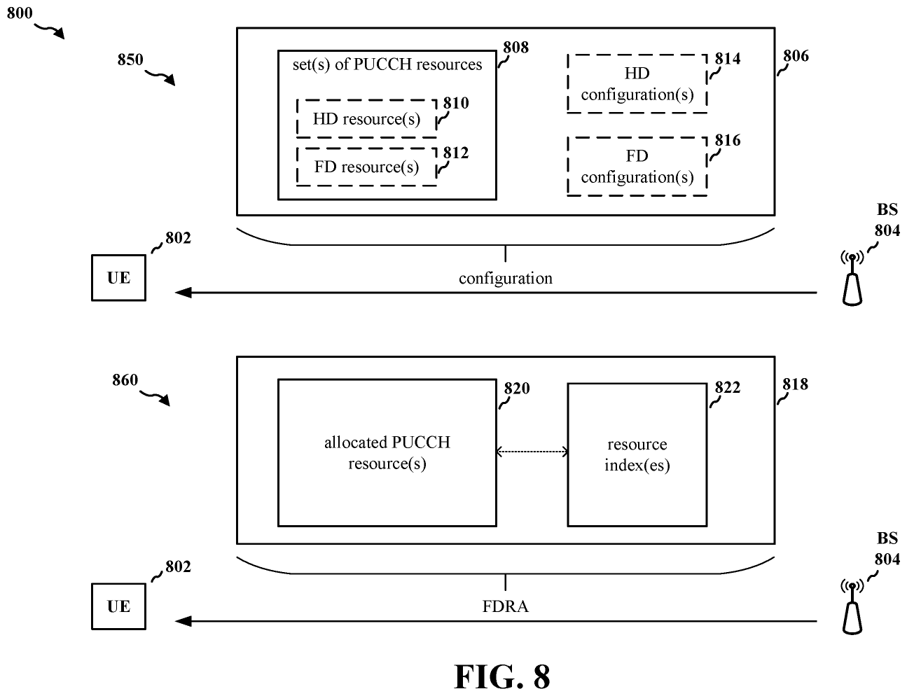

FIG. 8 is a diagram 800 illustrating examples for sets and allocations of resources, in various aspects. Diagram 800 shows a UE 802 and a base station 804 in context of two transmissions: a transmission 850 and a transmission 860.

For the transmission 850, the UE 802 receives, as transmitted from the base station 804, a configuration 806. The configuration 806 may be a further aspect of the configuration 706, described above for FIG. 7. As shown, the configuration 806 may include a set(s) of PUCCH resources 808, e.g., a multi-CSI-PUCCH-ResourceList. The set(s) of PUCCH resources 808 may include at least one HD resource 810 (e.g., multi-CSI-PUCCH resource for a HD time periods such as an HD slot) and/or at least one FD resource 812 (e.g., multi-CSI-PUCCH resource for a FD time periods such as an FD slot). The at least one HD resource 810 may be associated with at least one HD configuration 814 (e.g., a configuration to apply in HD slots) in the configuration 806, and the at least one FD resource 812 may be associated with at least one FD configuration 816 (e.g., a configuration to apply in FD slots) in the configuration 806.

For the transmission 860, the UE 802 receives, as transmitted from the base station 804, an allocation of resources for uplink transmission including an FDRA 818. In aspects, the FDRA 818 may be transmitted to the UE 702 before or after the configuration 806. The FDRA 818 may include at least one allocated PUCCH resource 820. In aspects, each of the at least one allocated PUCCH resource 820 may be associated with a corresponding resource index of at least one resource index 822. In aspects for which the configuration 806 does not include separate/dedicated PUCCH resources for FD/SBFD (e.g., for the at least one FD resource 812 and/or the at least one FD configuration 816), availability, or unavailability, of a PUCCH resource may depend on the FDRA 818 (e.g., a FDRA-PUCCH) and DL/UL SB in the FD slot. The resources allocated by the FDRA 818 may be fully within an UL SB, or may overlap with a DL SB or a guard band of the FD slot.

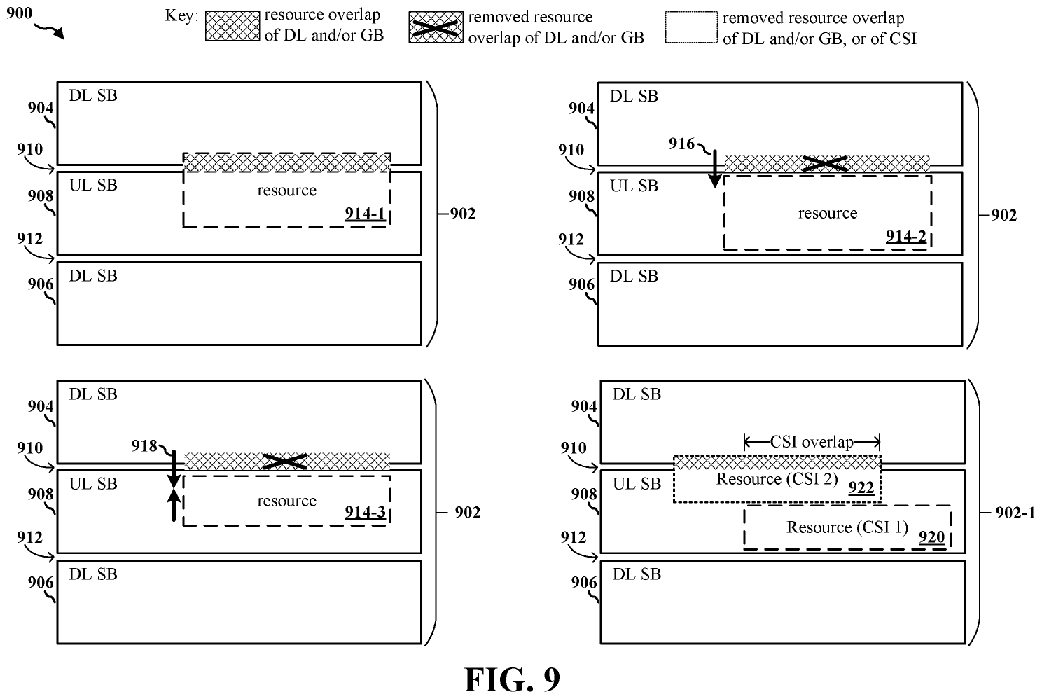

FIG. 9 is a diagram 900 illustrating examples of overlapping resources and resource adaptations, in various aspects. Diagram 900 shows three instances of a FD slot 902, and an alternate instance of the FD slot 902: FD slot 902-1, according to aspects. The FD slot 902 and the FD slot 902-1 may be SBFD slots. The FD slot 902 and the FD slot 902-1 are illustrated by way of example as including a DL SB 904, a DL SB 906, an UL SB 908, a guard band 910 between the DL SB 904 and the UL SB 908, and a guard band 912 between the UL SB 908 and the DL SB 906. HD slots include downlink resources or uplink resources rather than a combination of uplink and downlink resources.

A resource 914-1 (e.g., a PUCCH resource) is shown for transmission via the UL SB 908 of the FD slot 902, and in aspects, the resource 914-1 may be for transmission of UCI (e.g., multi-CSI, HARQ-ACK, SR, etc.) to a base station. As described herein, UL resources may overlap with guard bands (GBs) and DL resources, e.g., in FD operation. The resource 914-1 may have an portion thereof that overlaps with DL SB 904 and/or guard band 910 (illustrated as shaded by the Key in FIG. 9). Based on this overlap conflict, the resource 914-1 may not normally be available for UL transmission. However, according to aspects herein, the resource 914-1 may be adapted (as a resource 914-2 via an adaptation 916 and/or a resource 914-3 via an adaptation 918) to enable UL transmission thereof without overlap conflicts.

Regarding the adaptation 916, in some aspects, the resource 914-1 may be altered in frequency via the adaptation 916, e.g., shifted, to remove the overlap with DL SB 904 and/or guard band 910, resulting in the resource 914-2, which fits in the UL SB 908.

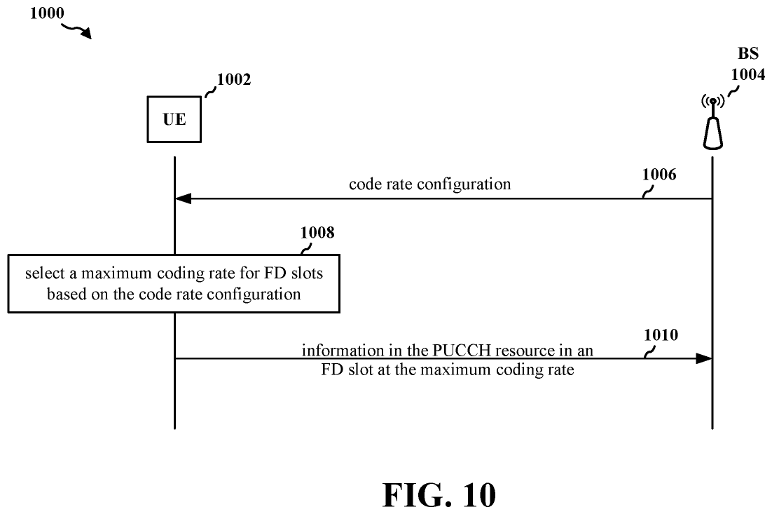

Regarding the adaptation 918, in some aspects, the resource 914-1 may be altered in size via the adaptation 918, e.g., reduced, to remove the overlap with DL SB 904 and/or guard band 910, resulting in the resource 914-3, which fits in the UL SB 908. The adaptation 918 may be an extension of the aspects described above for FIGS. 5, 6, for FD operation. That is, the adaptation 918 may include, without limitation, a change or limit in a maximum code rate (e.g., ‘r’ as described above for FIGS. 5, 6; and/or as discussed below for FIG. 10), dropping/removing overlapping REs or RBs of a resource, dropping/removing overlapping frequency resources from a FDRA, selecting a PUCCH resource as the resource 914-3 from a set of multiple CSI PUCCH resources that are non-overlapping with the DL SB 904 or the guard band 910 in the FD slot 902, and/or the like.

For instance, and with reference to the aspects described above for FIGS. 5, 6, as extended for FD operation, if a PUCCH resource overlaps with a guard band/DL SB and is not dropped, the PUCCH resource may be adapted to fit in the UL SB based on partial availability of PUCCH REs. That is, the maximum number of RBs that includes the REs for the PUCCH resource size (e.g., M_{RB}(PUCCH) in FIGS. 5, 6) may be adapted or calculated based on the available REs. In such aspects, the adapted PUCCH resource size (e.g., M_{RB}(PUCCH) in FIGS. 5, 6, based on available REs) may be used to determine the payload size of the PUCCH resource and thus may affect which CSI reports are be transmitted/dropped, as described herein.

Based on this adaptation, in aspects, a UE may be configured to identify an overlap of an overlapping PUCCH resource (e.g., the resource 914-1) with at least one of a DL slot (e.g., the DL SB 904) or a guard band (e.g., the guard band 910) of a PUCCH. The UE may then be configured to adapt (e.g., the adaptation 918) an amount of available resources for the PUCCH resource (e.g., the resource 914-1) based on a removal of the overlap and a generation of an adapted PUCCH resource (e.g., the resource 914-3). In aspects, the removal of the overlap may be based on a first number of REs that are non-overlapping with the at least one of the DL slot (e.g., the DL SB 904) or the guard band (e.g., the guard band 910), and the generation of the adapted PUCCH resource (e.g., the resource 914-3) may be based on a number of RBs that include the first number of REs. Accordingly, aspects provide that the UE may be configured to transmit UCI in the FD slot (e.g., the FD slot 902) in the adapted PUCCH resource (e.g., the resource 914-3).

Regarding the FD slot 902-1, a resource 920 (e.g., a PUCCH resource with a first CSI 1) and a resource 922 (e.g., a PUCCH resource with a second CSI 2) are shown for transmission via the UL SB 908 of the FD slot 902-1, and in aspects, may be for transmission of UCI (e.g., CSI(s), HARQ-ACK, SR, etc.) to a base station. As described herein, UL resources may overlap with other UL resources (e.g., first CSI report 402, second CSI report 404 in FIG. 4D), and also may overlap with guard bands (GBs) and DL resources, e.g., in FD operation. The resource 922 may have an portion thereof that overlaps with DL SB 904 and/or guard band 910 (illustrated as shaded by the Key in FIG. 9), and may also have a portion thereof that overlaps with the resource 920. Based on these overlap conflicts, the resource 920 and/or the resource 922 may not normally be available for UL transmission. However, according to aspects herein, the resource 922 may be adapted to enable UL transmission of the resource 920 without overlap conflicts.

In addition to being configured to identify overlaps of UL resources with guard bands and/or DL SBs, a UE may be configured to identify an overlap in time between instances/occasions of first CSI (e.g., the CSI overlap for the resource 920 with CSI 1 and the resource 922 with CSI 2). In some aspects, the UE may be configured to drop transmission of the second CSI (e.g., resource 922 with CSI 2) based on not having a configuration for multiple CSI PUCCH resources and the second CSI (e.g., resource 922 with CSI 2) having a lower priority than the first CSI (e.g., resource 920 with CSI 1). In some aspects, the UE may be configured to compare a sum of (1) the payload size for the UCI and (2) a payload size for the first CSI (e.g., resource 920 with CSI 1) with a resource size of the PUCCH resource (e.g., resource 920). The UE may further be configured to drop at least a portion of one of the first CSI and the second CSI (e.g., the resource 920 with CSI 1 and the resource 922 with CSI 2) based on the sum being greater than the resource size of the PUCCH resource (e.g., resource 920). A UE may also be configured, where a second CSI (e.g., resource 922 with CSI 2) overlaps with at least one of a DL or a guard band frequency resource of a FD slot (e.g., 902-1), to drop transmission of the second CSI (e.g., resource 922 with CSI 2) based on not having a configuration for multiple CSI PUCCH resources and transmit the first CSI in the PUCCH resource (e.g., resource 922 with CSI 2).

FIG. 10 is a call flow diagram 1000 for wireless communications, in various aspects. Call flow diagram 1000 illustrates UCI and multi-CSI multiplexing on PUCCH for SBFD by a UE (e.g., a UE 1002) that may communicate with a network node (a base station 1004, such as a gNB or other type of base station, by way of example, as shown). Aspects described for the base station 1004 may be performed by the base station in aggregated form and/or by one or more components of the base station 1004 in disaggregated form. Additionally, or alternatively, the aspects may be performed by the UE 1002 autonomously, in addition to, and/or in lieu of, operations of the base station 1004.

In the illustrated aspect, the UE 1002 may be configured to receive a code rate configuration 1006 from the base station 1004. In aspects, the code rate configuration 1006 may indicate a first maximum coding rate for UL transmission of first information via a PUCCH resource in FD slots. The maximum coding rate for FD slots may be included in the code rate configuration 1006 as a field, parameter, configuration, and/or the like with an identifier of “maxCodeRate” and/or “maxCodeRate-SBFD” for FD slots, in aspects. In some cases, the base station 1004 may suffer from self-interference and/or inter-base station cross link interference (CLI), and aspects for a maximum coding rate herein for FD/SBFD operation may maintain a reliability for PUCCH for different slot types (e.g., HD/FD). Additionally, a resource of configured PUCCH resources may be adapted to fit in an UL SB via the maximum coding rate options in the code rate configuration 1006.

The UE 1002 may be configured to select (at 1008) a maximum coding rate for FD slots based on the code rate configuration 1006. For example, the UE 1002 may select (at 1008) a maximum coding rate for FD slots to reduce one or more types of interference at the base station 1004. In such an example, the code rate configuration 1006 from the base station 1004 may include a single option for the maximum coding rate, and UE 1002 may select it by default according to the code rate configuration 1006. As another example, the UE 1002 may select (at 1008) a maximum coding rate for FD slots to adapt the bandwidth of the transmission in order to fit the configured resource in the UL SB of the FD slot. In aspects, the UE 1002 may be configured via the code rate configuration 1006, where the code rate configuration 1006 may be a PUCCH-config common to SBFD and HD, such that the code rate configuration 1006 includes two maximum coding rate fields (e.g., a “maxCodeRate” for HD slots and a “maxCodeRate-SBFD” for FD slots).

The UE 1002 may be configured to transmit information 1010 in the PUCCH resource in the FD slot at the maximum coding rate that is selected (at 1008). In aspects, the UE 1002 may be configured to transmit a first PUCCH with the information 1010 in the PUCCH resource of the FD slot with the first coding rate based on the first maximum coding rate. In some aspects, the UE 1002 may be configured to transmit a second PUCCH in the PUCCH resource of an HD slot with the a second maximum coding rate that is higher than the first maximum coding rate.

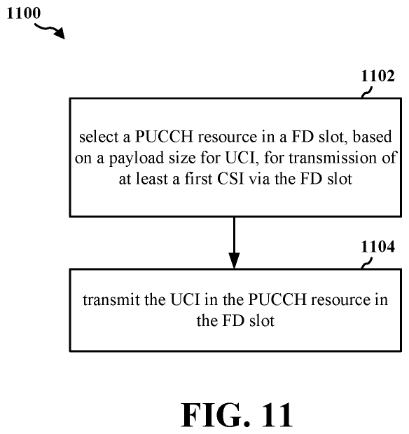

FIG. 11 is a flowchart 1100 of a method of wireless communication, in various aspects. The method may be performed by a UE (e.g., the UE 104, 702, 802, 1002; the apparatus 1604). In some aspects, the method may include aspects described in connection with the communication flow in FIG. 7 and/or aspects described in FIGS. 4A-D, 5, 6, 8, 9. The method provides for UCI and multi-CSI multiplexing on PUCCH for SBFD that enables a UE with configurations of PUCCH resources in SBFD UL transmissions, enables handling of overlaps for PUCCH resources in SBFD with guard bands and DL sub-bands, provides a UE with additional transmission options for multiplexing UCI/multi-CSI. Additionally, the method may enable a UE to adapt PUCCH resources to conform to the UL sub-band, multiplex UCI and multi-CSI via prioritization for transmissions in available resources, and configure maximum coding rates provide for maintained reliability of PUCCH resources in HD/FD transmissions.

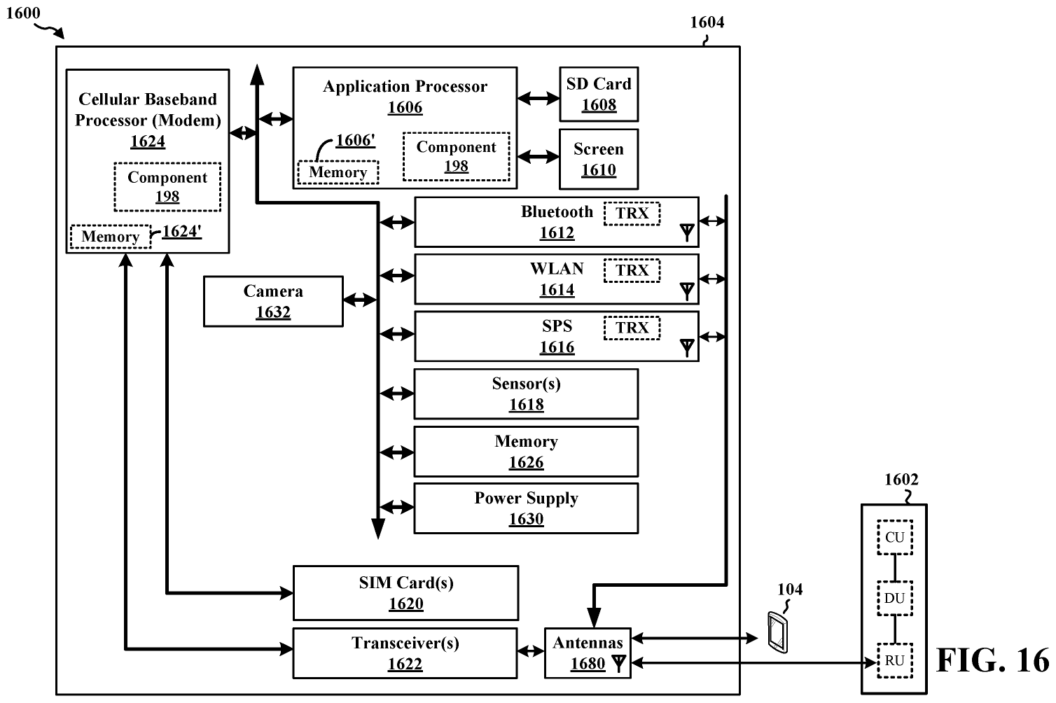

At 1102, the UE selects a PUCCH resource in a FD slot, based on a payload size for UCI, for transmission of at least a first CSI via the FD slot. As an example, the selection may be performed by one or more of the component 198, the transceiver(s) 1622, and/or the antenna 1680 in FIG. 16. FIGS. 5, 6, 7, 8, 9 illustrate an example of the UE 702 performing such a selection for a PUCCH resource for transmission of the UCI, for a network node (e.g., the base station 704).

The UE 702 may be configured to select (at 710) a PUCCH resource (e.g., 502, 504, 506 in FIG. 5; 612 in FIG. 6; 914-2, 914-3, 918 in FIG. 9) in a FD slot (e.g., 902, 902-1 in FIG. 9), based on the payload size (e.g., determined at 708) (e.g., 580, 582, 584, 586 in FIG. 5; 682, 688, 690, 692 in FIG. 6), for transmission of at least a first CSI via the FD slot (e.g., 902, 902-1 in FIG. 9). The UE 702 may be configured to determine (at 708) (e.g., 580, 582, 584, 586 in FIG. 5; 682, 688, 690, 692 in FIG. 6) a payload size for the UCI 712 (e.g., 508, 510 in FIG. 5; 614, 616 in FIG. 6). The UE 702 may be configured to determine (at 708) the payload size based on one or more of a number of bits associated with the HARQ-ACK information (e.g., 580, 582, 584, 586 in FIG. 5; 682, 688, 690, 692 in FIG. 6) for the dynamic PDSCH of the UCI 712 (e.g., 508, 510 in FIG. 5; 614, 616 in FIG. 6), a number of bits associated with the SPS PDSCH (e.g., 580, 582, 584, 586 in FIG. 5; 682, 688, 690, 692 in FIG. 6) of the UCI 712 (e.g., 508, 510 in FIG. 5; 614, 616 in FIG. 6), a number of bits associated with the SR (e.g., 580, 582, 584, 586 in FIG. 5; 682, 688, 690, 692 in FIG. 6) of the UCI 712 (e.g., 508, 510 in FIG. 5; 614, 616 in FIG. 6), a number of bits associated with a CSI (e.g., 580, 582, 584, 586 in FIG. 5; 682, 688, 690, 692 in FIG. 6) of the UCI 712 (e.g., 508, 510 in FIG. 5; 614, 616 in FIG. 6), a number of cyclic redundancy check (CRC) bits (e.g., 580, 582, 584, 586 in FIG. 5; 682, 688, 690, 692 in FIG. 6) of the UCI 712 (e.g., 508, 510 in FIG. 5; 614, 616 in FIG. 6), and/or the like.

In one aspect, where the configuration 706 is comprised in a PUCCH configuration (e.g., 806 in FIG. 8) for FD and HD communication and includes a first configuration (e.g., 814 in FIG. 8) of resources associated with HD operations and a second configuration (e.g., 816 in FIG. 8) of resources associated with FD operations, the UE 702 may be configured to select the selected set of PUCCH resources (e.g., 808 in FIG. 8) based on the FD slot (e.g., 902, 902-1 in FIG. 9) having a FD slot type associated with the FD operation. In aspects, where the configuration 706 includes a first subset (e.g., 812 in FIG. 8) of resources associated with FD operation and a second subset (e.g., 810 in FIG. 8) of resources associated with HD operation, the PUCCH resource (e.g., 502, 504, 506 in FIG. 5; 612 in FIG. 6; 914-2, 914-3, 918 in FIG. 9) may be selected from the first subset (e.g., 812 in FIG. 8) of resources associated with the FD operation. The UE 702 may be configured to select (at 710) the PUCCH resource (e.g., 502, 504, 506 in FIG. 5; 612 in FIG. 6; 914-2, 914-3, 918 in FIG. 9) in the FD slot (e.g., 902, 902-1 in FIG. 9) from the set of multiple CSI PUCCH resources (e.g., 820 in FIG. 8) after removal of frequency resources from a FDRA (e.g., 818 in FIG. 8) that overlap with downlink or guard band frequency resources (e.g., 904, 906, 910, 912 in FIG. 9) in the FD slot (e.g., 902, 902-1 in FIG. 9). The UE 702 may be configured to select (at 710) the PUCCH resource (e.g., 502, 504, 506 in FIG. 5; 612 in FIG. 6; 914-2, 914-3, 918 in FIG. 9) in the FD slot (e.g., 902, 902-1 in FIG. 9) from the set of multiple CSI PUCCH resources (e.g., 820 in FIG. 8) that are non-overlapping with downlink or guard band frequency resources (e.g., 904, 906, 910, 912 in FIG. 9) in the FD slot (e.g., 902, 902-1 in FIG. 9).

At 1104, the UE transmits the UCI in the PUCCH resource in the FD slot. As an example, the transmission may be performed by one or more of the component 198, the transceiver(s) 1622, and/or the antenna 1680 in FIG. 16. FIGS. 5, 6, 7 illustrate an example of the UE 702 performing such a transmission, for a network node (e.g., the base station 704).

The UE 702 may be configured to transmit the UCI 712 (e.g., 508, 510 in FIG. 5; 614, 616 in FIG. 6; UCI in 914-1, 914-2, 914-3, 918 in FIG. 9) in the PUCCH resource (e.g., selected at 710) (e.g., 502, 504, 506 in FIG. 5; 612 in FIG. 6; 914-2, 914-3, 918 in FIG. 9) in the FD slot (e.g., 902, 902-1 in FIG. 9).

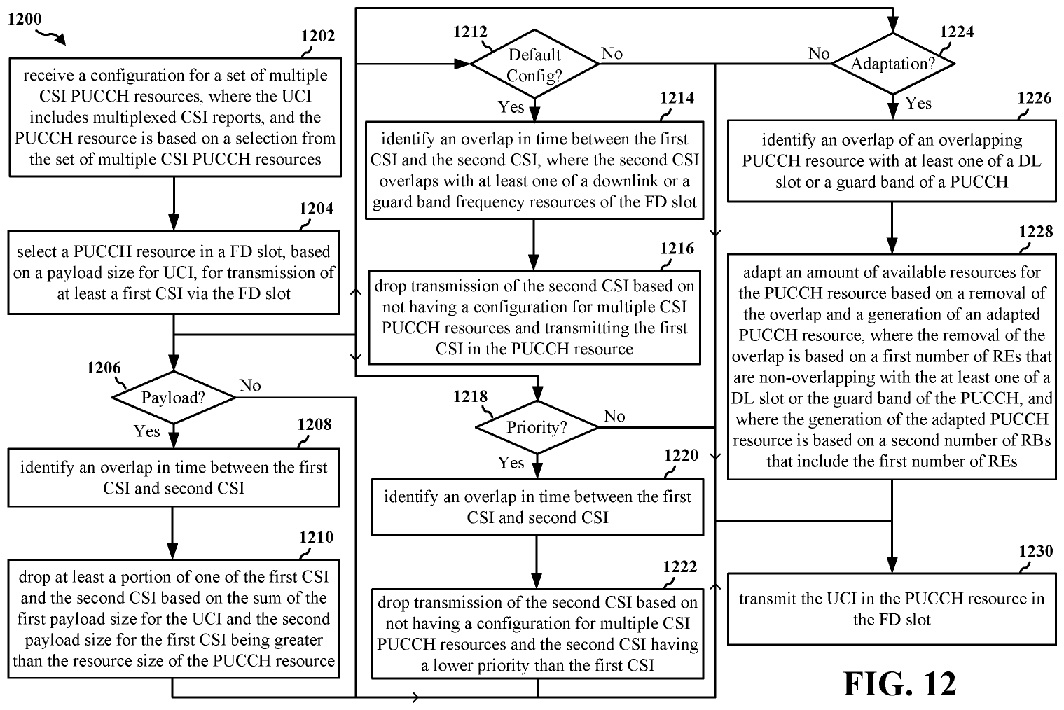

FIG. 12 is a flowchart 1200 of a method of wireless communication, in various aspects. The method may be performed by a UE (e.g., the UE 104, 702, 802, 1002; the apparatus 1604). In some aspects, the method may include aspects described in connection with the communication flow in FIG. 7 and/or aspects described in FIGS. 4A-D, 5, 6, 8, 9. The method provides for UCI and multi-CSI multiplexing on PUCCH for SBFD that enables a UE with configurations of PUCCH resources in SBFD UL transmissions, enables handling of overlaps for PUCCH resources in SBFD with guard bands and DL sub-bands, provides a UE with additional transmission options for multiplexing UCI/multi-CSI. Additionally, the method may enable a UE to adapt PUCCH resources to conform to the UL sub-band, multiplex UCI and multi-CSI via prioritization for transmissions in available resources, and configure maximum coding rates provide for maintained reliability of PUCCH resources in HD/FD transmissions.

At 1202, the UE receives a configuration for a set of multiple CSI PUCCH resources, where the UCI includes multiplexed CSI reports, and the PUCCH resource is based on a selection from the set of multiple CSI PUCCH resources. As an example, the reception may be performed by one or more of the component 198, the transceiver(s) 1622, and/or the antenna 1680 in FIG. 16. FIGS. 5, 6, 7, 8, 9 illustrate an example of the UE 702 performing such a selection for a PUCCH resource for transmission of the UCI, for a network node (e.g., the base station 704).

The UE 702 may be configured to receive a configuration 706 that is transmitted/provided by the base station 704. That is, the base station 704 may be configured to provide, and the UE 702 may be configured to receive a configuration for a set of multiple CSI PUCCH resources. In some aspects, the configuration may be provided in RRC signaling. In aspects, the UE 702 may select UCI 712 to transmit to the base station 704 via a PUCCH resource, e.g., based on the configuration 706. As an example, the configuration may include a resource list for multiple CSI PUCCH resources, e.g., which may be referred to as a multi-CSI-PUCCH-ResourceList. The UCI 712 may include multiplexed CSI reports, and the PUCCH resource may be selected from the set of multiple CSI PUCCH resources, e.g., a multi-CSI-PUCCH-ResourceList. The UCI 712 may further include, in some aspects, at least one of a HARQ-ACK information for a dynamic PDSCH, a SPS PDSCH, or a SR. The configuration 706 may be comprised in a PUCCH configuration for SBFD communication, e.g., an SBFD-specific PUCCH configuration, in some aspects. In other aspects, the configuration 706 may be comprised in a PUCCH configuration for FD and HD communications and may include separate resource lists for multi-CSI-PUCCH resources in FD slots and in HD slots. In such other aspects, the configuration 706 may include a first configuration of resources associated with HD operation (e.g., which may be referred to as a multi-CSI-PUCCH-ResourceList), and a second configuration of resources associated with FD operation, e.g., which may be referred to as a multi-CSI-PUCCH-ResourceList-SBFD. In aspects, the configuration 706 may include a single resource list, e.g., a single a multi-CSI-PUCCH-ResourceList, that includes a first subset of resources (e.g., a first set of indexes) associated with FD operation and a second subset of resources (e.g., a second set of indexes) associated with HD operation.

At 1204, the UE selects a PUCCH resource in a FD slot, based on a payload size for UCI, for transmission of at least a first CSI via the FD slot. As an example, the selection may be performed by one or more of the component 198, the transceiver(s) 1622, and/or the antenna 1680 in FIG. 16. FIGS. 5, 6, 7, 8, 9 illustrate an example of the UE 702 performing such a selection for a PUCCH resource for transmission of the UCI, for a network node (e.g., the base station 704).

The UE 702 may be configured to select (at 710) a PUCCH resource (e.g., 502, 504, 506 in FIG. 5; 612 in FIG. 6; 914-2, 914-3, 918 in FIG. 9) in a FD slot (e.g., 902, 902-1 in FIG. 9), based on the payload size (e.g., determined at 708) (e.g., 580, 582, 584, 586 in FIG. 5; 682, 688, 690, 692 in FIG. 6), for transmission of at least a first CSI via the FD slot (e.g., 902, 902-1 in FIG. 9). The UE 702 may be configured to determine (at 708) (e.g., 580, 582, 584, 586 in FIG. 5; 682, 688, 690, 692 in FIG. 6) a payload size for the UCI 712 (e.g., 508, 510 in FIG. 5; 614, 616 in FIG. 6). The UE 702 may be configured to determine (at 708) the payload size based on one or more of a number of bits associated with the HARQ-ACK information (e.g., 580, 582, 584, 586 in FIG. 5; 682, 688, 690, 692 in FIG. 6) for the dynamic PDSCH of the UCI 712 (e.g., 508, 510 in FIG. 5; 614, 616 in FIG. 6), a number of bits associated with the SPS PDSCH (e.g., 580, 582, 584, 586 in FIG. 5; 682, 688, 690, 692 in FIG. 6) of the UCI 712 (e.g., 508, 510 in FIG. 5; 614, 616 in FIG. 6), a number of bits associated with the SR (e.g., 580, 582, 584, 586 in FIG. 5; 682, 688, 690, 692 in FIG. 6) of the UCI 712 (e.g., 508, 510 in FIG. 5; 614, 616 in FIG. 6), a number of bits associated with a CSI (e.g., 580, 582, 584, 586 in FIG. 5; 682, 688, 690, 692 in FIG. 6) of the UCI 712 (e.g., 508, 510 in FIG. 5; 614, 616 in FIG. 6), a number of cyclic redundancy check (CRC) bits (e.g., 580, 582, 584, 586 in FIG. 5; 682, 688, 690, 692 in FIG. 6) of the UCI 712 (e.g., 508, 510 in FIG. 5; 614, 616 in FIG. 6), and/or the like.

In one aspect, where the configuration 706 is comprised in a PUCCH configuration (e.g., 806 in FIG. 8) for FD and HD communication and includes a first configuration (e.g., 814 in FIG. 8) of resources associated with HD operations and a second configuration (e.g., 816 in FIG. 8) of resources associated with FD operations, the UE 702 may be configured to select the selected set of PUCCH resources (e.g., 808 in FIG. 8) based on the FD slot (e.g., 902, 902-1 in FIG. 9) having a FD slot type associated with the FD operation. In aspects, where the configuration 706 includes a first subset (e.g., 812 in FIG. 8) of resources associated with FD operation and a second subset (e.g., 810 in FIG. 8) of resources associated with HD operation, the PUCCH resource (e.g., 502, 504, 506 in FIG. 5; 612 in FIG. 6; 914-2, 914-3, 918 in FIG. 9) may be selected from the first subset (e.g., 812 in FIG. 8) of resources associated with the FD operation. The UE 702 may be configured to select (at 710) the PUCCH resource (e.g., 502, 504, 506 in FIG. 5; 612 in FIG. 6; 914-2, 914-3, 918 in FIG. 9) in the FD slot (e.g., 902, 902-1 in FIG. 9) from the set of multiple CSI PUCCH resources (e.g., 820 in FIG. 8) after removal of frequency resources from a FDRA (e.g., 818 in FIG. 8) that overlap with downlink or guard band frequency resources (e.g., 904, 906, 910, 912 in FIG. 9) in the FD slot (e.g., 902, 902-1 in FIG. 9). The UE 702 may be configured to select (at 710) the PUCCH resource (e.g., 502, 504, 506 in FIG. 5; 612 in FIG. 6; 914-2, 914-3, 918 in FIG. 9) in the FD slot (e.g., 902, 902-1 in FIG. 9) from the set of multiple CSI PUCCH resources (e.g., 820 in FIG. 8) that are non-overlapping with downlink or guard band frequency resources (e.g., 904, 906, 910, 912 in FIG. 9) in the FD slot (e.g., 902, 902-1 in FIG. 9).

From 1204, flowchart 1200 may continue to one or more of 1206, 1212, 1218, and/or 1224. That is, a UE may be configured to perform determinations for one or more of 1206, 1212, 1218, and/or 1224, according to aspects herein.

At 1206, the UE determines if a dropping criteria for payload size is configured. As an example, the determination may be performed by one or more of the component 198, the transceiver(s) 1622, and/or the antenna 1680 in FIG. 16. If a dropping criteria for payload size is configured, flowchart 1200 may continue to 1208; if not, flowchart 1200 may continue to 1230.

At 1208, the UE identifies an overlap in time between the first CSI and a second CSI. As an example, the identification may be performed by one or more of the component 198, the transceiver(s) 1622, and/or the antenna 1680 in FIG. 16. FIG. 9 illustrates an example of the UE 702 performing such an identification for an overlap.

Diagram 900 shows three instances of a FD slot 902, and an alternate instance of the FD slot 902: FD slot 902-1, according to aspects. The FD slot 902 and the FD slot 902-1 may be SBFD slots. The FD slot 902 and the FD slot 902-1 are illustrated by way of example as including a DL SB 904, a DL SB 906, an UL SB 908, a guard band 910 between the DL SB 904 and the UL SB 908, and a guard band 912 between the UL SB 908 and the DL SB 906. HD slots include downlink resources or uplink resources rather than a combination of uplink and downlink resources. In addition to being configured to identify overlaps of UL resources with guard bands and/or DL SBs, a UE may be configured to identify an overlap in time between instances/occasions of first CSI (e.g., the CSI overlap for the resource 920 with CSI 1 and the resource 922 with CSI 2).

At 1210, the UE drops at least a portion of one of the first CSI and the second CSI based on the sum of the first payload size for the UCI and the second payload size for the first CSI being greater than the resource size of the PUCCH resource. As an example, the drop may be performed by one or more of the component 198, the transceiver(s) 1622, and/or the antenna 1680 in FIG. 16. FIG. 9 illustrates an example of the UE 702 dropping such CSI based on payload size.

In some aspects, the UE may be configured to compare a sum of (1) the payload size for the UCI and (2) a payload size for the first CSI (e.g., resource 920 with CSI 1) with a resource size of the PUCCH resource (e.g., resource 920). The UE may further be configured to drop at least a portion of one of the first CSI and the second CSI (e.g., the resource 920 with CSI 1 and the resource 922 with CSI 2) based on the sum being greater than the resource size of the PUCCH resource (e.g., resource 920).

At 1212, the UE determines if a default dropping criteria is configured. As an example, the determination may be performed by one or more of the component 198, the transceiver(s) 1622, and/or the antenna 1680 in FIG. 16. If a default dropping criteria is configured, flowchart 1200 may continue to 1214; if not, flowchart 1200 may continue to 1230.

At 1214, the UE identifies an overlap in time between the first CSI and second CSI, where the second CSI overlaps with at least one of a downlink or a guard band frequency resources of the FD slot. As an example, the identification may be performed by one or more of the component 198, the transceiver(s) 1622, and/or the antenna 1680 in FIG. 16. FIG. 9 illustrates an example of the UE 702 performing such an identification for an overlap.

Diagram 900 shows three instances of a FD slot 902, and an alternate instance of the FD slot 902: FD slot 902-1, according to aspects. The FD slot 902 and the FD slot 902-1 may be SBFD slots. The FD slot 902 and the FD slot 902-1 are illustrated by way of example as including a DL SB 904, a DL SB 906, an UL SB 908, a guard band 910 between the DL SB 904 and the UL SB 908, and a guard band 912 between the UL SB 908 and the DL SB 906. HD slots include downlink resources or uplink resources rather than a combination of uplink and downlink resources. In addition to being configured to identify overlaps of UL resources with guard bands and/or DL SBs, a UE may be configured to identify an overlap in time between instances/occasions of first CSI (e.g., the CSI overlap for the resource 920 with CSI 1 and the resource 922 with CSI 2).

At 1216, the UE drops transmission of the second CSI based on not having a configuration for multiple CSI PUCCH resources and transmitting the first CSI in the PUCCH resource. As an example, the drop may be performed by one or more of the component 198, the transceiver(s) 1622, and/or the antenna 1680 in FIG. 16. FIG. 9 illustrates an example of the UE 702 dropping a second CSI based on a lack of such a configuration.

A UE may also be configured, where a second CSI (e.g., resource 922 with CSI 2) overlaps with at least one of a DL or a guard band frequency resource of a FD slot (e.g., 902-1), to drop transmission of the second CSI (e.g., resource 922 with CSI 2) based on not having a configuration for multiple CSI PUCCH resources and transmit the first CSI in the PUCCH resource (e.g., resource 922 with CSI 2).

At 1218, the UE determines if a dropping criteria for priority is configured. As an example, the determination may be performed by one or more of the component 198, the transceiver(s) 1622, and/or the antenna 1680 in FIG. 16. If a dropping criteria for priority is configured, flowchart 1200 may continue to 1220; if not, flowchart 1200 may continue to 1230.

At 1220, the UE identifies an overlap in time between the first CSI and second CSI. As an example, the identification may be performed by one or more of the component 198, the transceiver(s) 1622, and/or the antenna 1680 in FIG. 16. FIG. 9 illustrates an example of the UE 702 performing such an identification for an overlap.

Diagram 900 shows three instances of a FD slot 902, and an alternate instance of the FD slot 902: FD slot 902-1, according to aspects. The FD slot 902 and the FD slot 902-1 may be SBFD slots. The FD slot 902 and the FD slot 902-1 are illustrated by way of example as including a DL SB 904, a DL SB 906, an UL SB 908, a guard band 910 between the DL SB 904 and the UL SB 908, and a guard band 912 between the UL SB 908 and the DL SB 906. HD slots include downlink resources or uplink resources rather than a combination of uplink and downlink resources. In addition to being configured to identify overlaps of UL resources with guard bands and/or DL SBs, a UE may be configured to identify an overlap in time between instances/occasions of first CSI (e.g., the CSI overlap for the resource 920 with CSI 1 and the resource 922 with CSI 2).

At 1222, the UE drops transmission of the second CSI based on not having a configuration for multiple CSI PUCCH resources and the second CSI having a lower priority than the first CSI. As an example, the drop may be performed by one or more of the component 198, the transceiver(s) 1622, and/or the antenna 1680 in FIG. 16. FIG. 9 illustrates an example of the UE 702 dropping a second CSI based on a lack of such a configuration and on priority.

In some aspects, the UE may be configured to drop transmission of the second CSI (e.g., resource 922 with CSI 2) based on not having a configuration for multiple CSI PUCCH resources and the second CSI (e.g., resource 922 with CSI 2) having a lower priority than the first CSI (e.g., resource 920 with CSI 1).

At 1224, the UE determines if a dropping criteria for adaptation is configured. As an example, the determination may be performed by one or more of the component 198, the transceiver(s) 1622, and/or the antenna 1680 in FIG. 16. If a dropping criteria for adaptation is configured, flowchart 1200 may continue to 1226; if not, flowchart 1200 may continue to 1230.

At 1226, the UE identifies an overlap of an overlapping PUCCH resource with at least one of a DL slot or a guard band of the PUCCH. As an example, the identification may be performed by one or more of the component 198, the transceiver(s) 1622, and/or the antenna 1680 in FIG. 16. FIG. 9 illustrates an example of the UE 702 performing such an identification for an overlap.

Diagram 900 shows three instances of a FD slot 902, and an alternate instance of the FD slot 902: FD slot 902-1, according to aspects. The FD slot 902 and the FD slot 902-1 may be SBFD slots. The FD slot 902 and the FD slot 902-1 are illustrated by way of example as including a DL SB 904, a DL SB 906, an UL SB 908, a guard band 910 between the DL SB 904 and the UL SB 908, and a guard band 912 between the UL SB 908 and the DL SB 906. HD slots include downlink resources or uplink resources rather than a combination of uplink and downlink resources.

At 1228, the UE adapts an amount of available resources for the PUCCH resource based on a removal of the overlap and a generation of an adapted PUCCH resource, where the removal of the overlap is based on a first number of REs that are non-overlapping with the at least one of a DL slot or the guard band of the PUCCH, and where the generation of the adapted PUCCH resource is based on a second number of RBs that include the first number of REs. As an example, the adaptation may be performed by one or more of the component 198, the transceiver(s) 1622, and/or the antenna 1680 in FIG. 16. FIG. 9 illustrates an example of the UE 702 adapting an amount of such resources. A resource 914-1 (e.g., a PUCCH resource) is shown for transmission via the UL SB 908 of the FD slot 902, and in aspects, the resource 914-1 may be for transmission of UCI (e.g., multi-CSI, HARQ-ACK, SR, etc.) to a base station. As described herein, UL resources may overlap with guard bands (GBs) and DL resources, e.g., in FD operation. The resource 914-1 may have an portion thereof that overlaps with DL SB 904 and/or guard band 910 (illustrated as shaded by the Key in FIG. 9). Based on this overlap conflict, the resource 914-1 may not normally be available for UL transmission. However, according to aspects herein, the resource 914-1 may be adapted (as a resource 914-2 via an adaptation 916 and/or a resource 914-3 via an adaptation 918) to enable UL transmission thereof without overlap conflicts.

Regarding the adaptation 916, in some aspects, the resource 914-1 may be altered in frequency via the adaptation 916, e.g., shifted, to remove the overlap with DL SB 904 and/or guard band 910, resulting in the resource 914-2, which fits in the UL SB 908. Regarding the adaptation 918, in some aspects, the resource 914-1 may be altered in size via the adaptation 918, e.g., reduced, to remove the overlap with DL SB 904 and/or guard band 910, resulting in the resource 914-3, which fits in the UL SB 908. The adaptation 918 may be an extension of the aspects described above for FIGS. 5, 6, for FD operation. That is, the adaptation 918 may include, without limitation, a change or limit in a maximum code rate (e.g., ‘r’ as described above for FIGS. 5, 6; and/or as discussed below for FIG. 10), dropping/removing overlapping REs or RBs of a resource, dropping/removing overlapping frequency resources from a FDRA, selecting a PUCCH resource as the resource 914-3 from a set of multiple CSI PUCCH resources that are non-overlapping with the DL SB 904 or the guard band 910 in the FD slot 902, and/or the like.

For instance, and with reference to the aspects described above for FIGS. 5, 6, as extended for FD operation, if a PUCCH resource overlaps with a guard band/DL SB and is not dropped, the PUCCH resource may be adapted to fit in the UL SB based on partial availability of PUCCH REs. That is, the maximum number of RBs that includes the REs for the PUCCH resource size (e.g., M_{RB}(PUCCH) in FIGS. 5, 6) may be adapted or calculated based on the available REs. In such aspects, the adapted PUCCH resource size (e.g., M_{RB}(PUCCH) in FIGS. 5, 6, based on available REs) may be used to determine the payload size of the PUCCH resource and thus may affect which CSI reports are be transmitted/dropped, as described herein.

Based on this adaptation, in aspects, a UE may be configured to identify an overlap of an overlapping PUCCH resource (e.g., the resource 914-1) with at least one of a DL slot (e.g., the DL SB 904) or a guard band (e.g., the guard band 910) of a PUCCH. The UE may then be configured to adapt (e.g., the adaptation 918) an amount of available resources for the PUCCH resource (e.g., the resource 914-1) based on a removal of the overlap and a generation of an adapted PUCCH resource (e.g., the resource 914-3). In aspects, the removal of the overlap may be based on a first number of REs that are non-overlapping with the at least one of the DL slot (e.g., the DL SB 904) or the guard band (e.g., the guard band 910), and the generation of the adapted PUCCH resource (e.g., the resource 914-3) may be based on a number of RBs that include the first number of REs. Accordingly, aspects provide that the UE may be configured to transmit UCI in the FD slot (e.g., the FD slot 902) in the adapted PUCCH resource (e.g., the resource 914-3).

Regarding the FD slot 902-1, a resource 920 (e.g., a PUCCH resource with a first CSI 1) and a resource 922 (e.g., a PUCCH resource with a second CSI 2) are shown for transmission via the UL SB 908 of the FD slot 902-1, and in aspects, may be for transmission of UCI (e.g., CSI(s), HARQ-ACK, SR, etc.) to a base station. As described herein, UL resources may overlap with other UL resources (e.g., first CSI report 402, second CSI report 404 in FIG. 4D), and also may overlap with guard bands (GBs) and DL resources, e.g., in FD operation. The resource 922 may have an portion thereof that overlaps with DL SB 904 and/or guard band 910 (illustrated as shaded by the Key in FIG. 9), and may also have a portion thereof that overlaps with the resource 920. Based on these overlap conflicts, the resource 920 and/or the resource 922 may not normally be available for UL transmission. However, according to aspects herein, the resource 922 may be adapted to enable UL transmission of the resource 920 without overlap conflicts.

At 1230, the UE transmits the UCI in the PUCCH resource in the FD slot. As an example, the transmission may be performed by one or more of the component 198, the transceiver(s) 1622, and/or the antenna 1680 in FIG. 16. FIGS. 5, 6, 7 illustrate an example of the UE 702 performing such a transmission, for a network node (e.g., the base station 704).

The UE 702 may be configured to transmit the UCI 712 (e.g., 508, 510 in FIG. 5; 614, 616 in FIG. 6; UCI in 914-1, 914-2, 914-3, 918 in FIG. 9) in the PUCCH resource (e.g., selected at 710) (e.g., 502, 504, 506 in FIG. 5; 612 in FIG. 6; 914-2, 914-3, 918 in FIG. 9) in the FD slot (e.g., 902, 902-1 in FIG. 9).

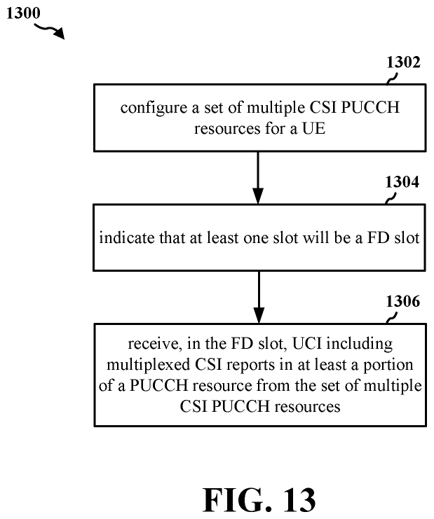

FIG. 13 is a flowchart 1300 of a method of wireless communication, in various aspects. The method may be performed by a base station (e.g., the base station 102, 704, 804, 1004; the network entity 1602, 1702. The method may be performed by a UE (e.g., the UE 104, 702, 802, 1002; the apparatus 1604). In some aspects, the method may include aspects described in connection with the communication flow in FIG. 7 and/or aspects described in FIGS. 4A-D, 5, 6, 8, 9. The method provides for UCI and multi-CSI multiplexing on PUCCH for SBFD that enables a UE with configurations of PUCCH resources in SBFD UL transmissions, enables handling of overlaps for PUCCH resources in SBFD with guard bands and DL sub-bands, provides a UE with additional transmission options for multiplexing UCI/multi-CSI. Additionally, the method may enable a UE to adapt PUCCH resources to conform to the UL sub-band, multiplex UCI and multi-CSI via prioritization for transmissions in available resources, and configure maximum coding rates provide for maintained reliability of PUCCH resources in HD/FD transmissions.

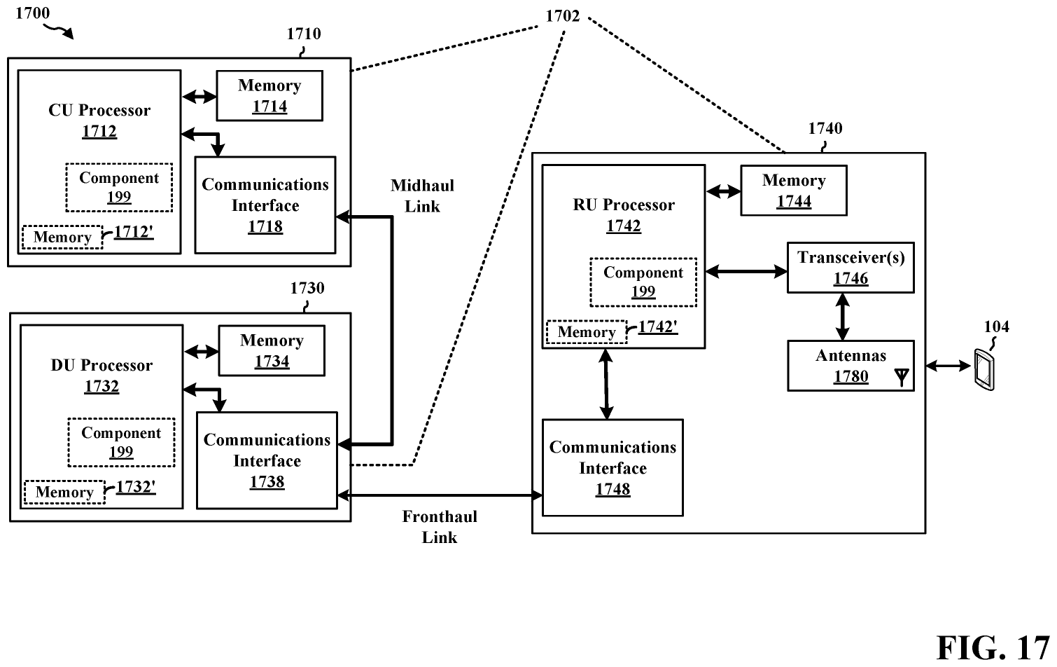

In 1302, the base station configures a set of multiple CSI PUCCH resources for a UE. As an example, the configuration may be performed by one or more of the component 199, the transceiver(s) 1746, and/or the antenna 1780 in FIG. 17. FIGS. 5, 6, 7 illustrate an example of the base station 704 performing such a configuration, for a UE (e.g., the UE 702).

The base station 704 may be configured to configure the UE 702 with the configuration 706 (e.g., 806 (may also include 818) in FIG. 8). For example, the UE 702 may be configured to receive the configuration 706 (e.g., 806 (may also include 818) in FIG. 8) that is transmitted/provided by the base station 704. The base station 704 may be configured to provide, and the UE 702 may be configured to receive the configuration 706 (e.g., 806 (may also include 818) in FIG. 8) for a set of multiple CSI PUCCH resources (e.g., 808, 812 (may also include 818/820) in FIG. 8). In aspects, the UE 702 may select a UCI 712 to transmit to the base station 704 via a PUCCH resource (e.g., 502, 504, 506 in FIG. 5; 612 in FIG. 6; 808 in FIG. 8; 914-2, 914-3, 918 in FIG. 9), e.g., based on the configuration 706.

In 1304, the base station indicates that at least one slot will be a FD slot. As an example, the indication may be performed by one or more of the component 199, the transceiver(s) 1746, and/or the antenna 1780 in FIG. 17. FIGS. 7, 8, 9 illustrates an example of the base station 704 performing such an indication, for a UE (e.g., the UE 702).

For instance, the base station 704 may indicate to the UE 702 of a FD slot (e.g., 902, 902-1 in FIG. 9) via the configuration 706 (e.g., 806 in FIG. 8), an FDRA/FDRA-PUCCH (e.g., 818 in FIG. 8), and/or the like, as described herein.

In 1306, the base station receives, in the FD slot, UCI including multiplexed CSI reports in at least a portion of a PUCCH resource from the set of multiple CSI PUCCH resources. As an example, the reception may be performed by one or more of the component 199, the transceiver(s) 1746, and/or the antenna 1780 in FIG. 17. FIGS. 5, 6, 7, 9 illustrate an example of the base station 704 performing such a reception, from a UE (e.g., the UE 702).

The base station 704 may be configured to receive, from the UE 702, the UCI 712 (e.g., 508, 510 in FIG. 5; 614, 616 in FIG. 6; UCI in 914-1, 914-2, 914-3, 918 in FIG. 9). In aspects, the UCI 712 (e.g., 508, 510 in FIG. 5; 614, 616 in FIG. 6; UCI in 914-1, 914-2, 914-3, 918 in FIG. 9) may be in the PUCCH resource (e.g., selected at 710) (e.g., 502, 504, 506 in FIG. 5; 612 in FIG. 6; 914-2, 914-3, 918 in FIG. 9) in the FD slot (e.g., 902, 902-1 in FIG. 9). The UCI 712 may include multiplexed CSI reports (e.g., as in 508, 510 in FIG. 5; as in 614, 616 in FIG. 6), and the PUCCH resource (e.g., selected at 710) (e.g., 502, 504, 506 in FIG. 5; 612 in FIG. 6; 914-2, 914-3, 918 in FIG. 9) may be selected from the set of multiple CSI PUCCH resources (e.g., 808, 812 (may also include 818/820) in FIG. 8). The UCI 712 may further include, in some aspects, at least one of a HARQ-ACK information for a dynamic PDSCH, a SPS PDSCH, or a SR. The configuration 706 (e.g., 806 in FIG. 8) may be comprised in a PUCCH configuration (e.g., 806 in FIG. 8) for SBFD communication, in some aspects. In other aspects, the configuration 706 may be comprised in a PUCCH configuration (e.g., 806 in FIG. 8) for FD and HD communications. In such other aspects. the configuration 706 (e.g., 806 in FIG. 8) may include a first configuration (e.g., 814 in FIG. 8) of resources associated with HD operation and a second configuration (e.g., 816 in FIG. 8) of resources associated with FD operation. In aspects, the configuration 706 (e.g., 806 in FIG. 8) may include a first subset (e.g., 812 in FIG. 8) of resources associated with FD operation and a second subset (e.g., 810 in FIG. 8) of resources associated with HD operation.

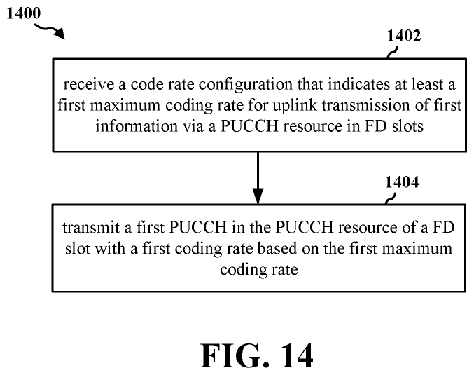

FIG. 14 is a flowchart 1400 of a method of wireless communication, in various aspects. The method may be performed by a UE (e.g., the UE 104, 702, 802, 1002; the apparatus 1604). In some aspects, the method may include aspects described in connection with the communication flow in FIG. 10 and/or aspects described in FIGS. 4A-D, 5, 6, 8, 9. The method provides for UCI and multi-CSI multiplexing on PUCCH for SBFD that enables a UE with configurations of PUCCH resources in SBFD UL transmissions, enables handling of overlaps for PUCCH resources in SBFD with guard bands and DL sub-bands, provides a UE with additional transmission options for multiplexing UCI/multi-CSI. Additionally, the method may enable a UE to adapt PUCCH resources to conform to the UL sub-band, multiplex UCI and multi-CSI via prioritization for transmissions in available resources, and configure maximum coding rates provide for maintained reliability of PUCCH resources in HD/FD transmissions.

At 1402, the UE receives a code rate configuration that indicates at least a first maximum coding rate for uplink transmission of first information via a PUCCH resource in FD slots. As an example, the reception may be performed by one or more of the component 198, the transceiver(s) 1622, and/or the antenna 1680 in FIG. 16. FIGS. 5, 6, 10 illustrate an example of the UE 1002 performing such a reception, for a network node (e.g., the base station 1004).

The UE 1002 may be configured to receive a code rate configuration 1006 (e.g., may be included in 706 in FIG. 7 or 806 in FIG. 8) from the base station 1004. In aspects, the code rate configuration 1006 may indicate a first maximum coding rate (e.g., ‘r’ in FIGS. 5, 6) for UL transmission (e.g., 908 in FIG. 9) of first information via a PUCCH resource (e.g., 502, 504, 506 in FIG. 5; 612 in FIG. 6; 808 in FIG. 8; 914-2, 914-3, 918 in FIG. 9) in FD slots (e.g., 902, 902-1 in FIG. 9). The maximum coding rate (e.g., ‘r’ in FIGS. 5, 6) for FD slots (e.g., 902, 902-1 in FIG. 9) may be included in the code rate configuration 1006 as a field, parameter, configuration, and/or the like with an identifier of “maxCodeRate” and/or “maxCodeRate-SBFD” for FD slots (e.g., 902, 902-1 in FIG. 9), in aspects. In some cases, the base station 1004 may suffer from self-interference and/or inter-base station cross link interference (CLI), and aspects for a maximum coding rate herein (e.g., ‘r’ in FIGS. 5, 6) for FD/SBFD operation may maintain a reliability for PUCCH for different slot types (e.g., HD/FD). Additionally, a resource of configured PUCCH resources (e.g., 502, 504, 506 in FIG. 5; 612 in FIG. 6; 808 in FIG. 8; 914-2, 914-3, 918 in FIG. 9) may be adapted to fit in an UL SB (e.g., 908 in FIG. 9) via the maximum coding rate (e.g., ‘r’ in FIGS. 5, 6) options in the code rate configuration 1006.

At 1404, the UE transmits a first PUCCH in the PUCCH resource of a FD slot with a first coding rate based on the first maximum coding rate. As an example, the transmission may be performed by one or more of the component 198, the transceiver(s) 1622, and/or the antenna 1680 in FIG. 16. FIGS. 5, 6, 10 illustrate an example of the UE 1002 performing such a transmission, for a network node (e.g., the base station 1004).

The UE 1002 may be configured to select (at 1008) a maximum coding rate (e.g., ‘r’ in FIGS. 5, 6) for FD slots (e.g., 902, 902-1 in FIG. 9) based on the code rate configuration 1006. For example, the UE 1002 may select (at 1008) a maximum coding rate (e.g., ‘r’ in FIGS. 5, 6) for FD slots (e.g., 902, 902-1 in FIG. 9) to reduce one or more types of interference at the base station 1004. In such an example, the code rate configuration 1006 from the base station 1004 may include a single option for the maximum coding rate (e.g., ‘r’ in FIGS. 5, 6), and UE 1002 may select it by default according to the code rate configuration 1006. As another example, the UE 1002 may select (at 1008) a maximum coding rate (e.g., ‘r’ in FIGS. 5, 6) for FD slots (e.g., 902, 902-1 in FIG. 9) to adapt the bandwidth of the transmission in order to fit the configured resource in the UL SB (e.g., 908 in FIG. 9) of the FD slot (e.g., 902, 902-1 in FIG. 9). In aspects, the UE 1002 may be configured via the code rate configuration 1006, where the code rate configuration 1006 may be a PUCCH-config common to SBFD and HD, such that the code rate configuration 1006 includes two maximum coding rate fields (e.g., a “maxCodeRate” for HD slots and a “maxCodeRate-SBFD” for FD slots (e.g., 902, 902-1 in FIG. 9)).

The UE 1002 may be configured to transmit information 1010 in the PUCCH resource in the FD slot (e.g., 902, 902-1 in FIG. 9) at the maximum coding rate (e.g., ‘r’ in FIGS. 5, 6) that is selected (at 1008). In aspects, the UE 1002 may be configured to transmit a first PUCCH with the information 1010 in the PUCCH resource of the FD slot (e.g., 902, 902-1 in FIG. 9) with the first coding rate (e.g., ‘r’ for HD in FIGS. 5, 6) based on the first maximum coding rate (e.g., ‘r’ in FIGS. 5, 6). In some aspects, the UE 1002 may be configured to transmit a second PUCCH in the PUCCH resource of an HD slot with the a second maximum coding rate (e.g., ‘r’ for HD in FIGS. 5, 6) that is higher than the first maximum coding rate (e.g., ‘r’ in FIGS. 5, 6).

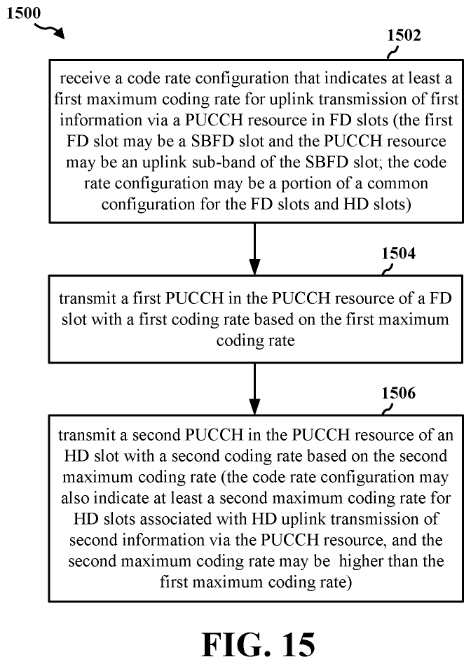

FIG. 15 is a flowchart 1500 of a method of wireless communication, in various aspects. The method may be performed by a UE (e.g., the UE 104, 702, 802, 1002; the apparatus 1604). In some aspects, the method may include aspects described in connection with the communication flow in FIG. 10 and/or aspects described in FIGS. 4A-D, 5, 6, 8, 9. The method provides for UCI and multi-CSI multiplexing on PUCCH for SBFD that enables a UE with configurations of PUCCH resources in SBFD UL transmissions, enables handling of overlaps for PUCCH resources in SBFD with guard bands and DL sub-bands, provides a UE with additional transmission options for multiplexing UCI/multi-CSI. Additionally, the method may enable a UE to adapt PUCCH resources to conform to the UL sub-band, multiplex UCI and multi-CSI via prioritization for transmissions in available resources, and configure maximum coding rates provide for maintained reliability of PUCCH resources in HD/FD transmissions.

At 1502, the UE receives a code rate configuration that indicates at least a first maximum coding rate for uplink transmission of first information via a PUCCH resource in FD slots. As an example, the reception may be performed by one or more of the component 198, the transceiver(s) 1622, and/or the antenna 1680 in FIG. 16. FIGS. 5, 6, 7, 8, 9, 10 illustrate an example of the UE 1002 performing such a reception, for a network node (e.g., the base station 1004).

The UE 1002 may be configured to receive a code rate configuration 1006 (e.g., may be included in 706 in FIG. 7 or 806 in FIG. 8) from the base station 1004. In aspects, the code rate configuration 1006 may indicate a first maximum coding rate (e.g., ‘r’ in FIGS. 5, 6) for UL transmission (e.g., 908 in FIG. 9) of first information via a PUCCH resource (e.g., 502, 504, 506 in FIG. 5; 612 in FIG. 6; 808 in FIG. 8; 914-2, 914-3, 918 in FIG. 9) in FD slots (e.g., 902, 902-1 in FIG. 9). The maximum coding rate (e.g., ‘r’ in FIGS. 5, 6) for FD slots (e.g., 902, 902-1 in FIG. 9) may be included in the code rate configuration 1006 as a field, parameter, configuration, and/or the like with an identifier of “maxCodeRate” and/or “maxCodeRate-SBFD” for FD slots (e.g., 902, 902-1 in FIG. 9), in aspects. In some cases, the base station 1004 may suffer from self-interference and/or inter-base station cross link interference (CLI), and aspects for a maximum coding rate herein (e.g., ‘r’ in FIGS. 5, 6) for FD/SBFD operation may maintain a reliability for PUCCH for different slot types (e.g., HD/FD). Additionally, a resource of configured PUCCH resources (e.g., 502, 504, 506 in FIG. 5; 612 in FIG. 6; 808 in FIG. 8; 914-2, 914-3, 918 in FIG. 9) may be adapted to fit in an UL SB (e.g., 908 in FIG. 9) via the maximum coding rate (e.g., ‘r’ in FIGS. 5, 6) options in the code rate configuration 1006.

At 1504, the UE transmits a first PUCCH in the PUCCH resource of a FD slot with a first coding rate based on the first maximum coding rate. As an example, the transmission may be performed by one or more of the component 198, the transceiver(s) 1622, and/or the antenna 1680 in FIG. 16. FIGS. 5, 6, 8, 9, 10 illustrate an example of the UE 1002 performing such a transmission, for a network node (e.g., the base station 1004).

The UE 1002 may be configured to select (at 1008) a maximum coding rate (e.g., ‘r’ in FIGS. 5, 6) for FD slots (e.g., 902, 902-1 in FIG. 9) based on the code rate configuration 1006. For example, the UE 1002 may select (at 1008) a maximum coding rate (e.g., ‘r’ in FIGS. 5, 6) for FD slots (e.g., 902, 902-1 in FIG. 9) to reduce one or more types of interference at the base station 1004. In such an example, the code rate configuration 1006 from the base station 1004 may include a single option for the maximum coding rate (e.g., ‘r’ in FIGS. 5, 6), and UE 1002 may select it by default according to the code rate configuration 1006. As another example, the UE 1002 may select (at 1008) a maximum coding rate (e.g., ‘r’ in FIGS. 5, 6) for FD slots (e.g., 902, 902-1 in FIG. 9) to adapt the bandwidth of the transmission in order to fit the configured resource in the UL SB (e.g., 908 in FIG. 9) of the FD slot (e.g., 902, 902-1 in FIG. 9). In aspects, the UE 1002 may be configured via the code rate configuration 1006, where the code rate configuration 1006 may be a PUCCH-config common to SBFD and HD, such that the code rate configuration 1006 includes two maximum coding rate fields (e.g., a “maxCodeRate” for HD slots and a “maxCodeRate-SBFD” for FD slots (e.g., 902, 902-1 in FIG. 9)). The UE 1002 may be configured to transmit information 1010 in the PUCCH resource (e.g., 502, 504, 506 in FIG. 5; 612 in FIG. 6; 808 in FIG. 8; 914-2, 914-3, 918 in FIG. 9) in the FD slot (e.g., 902, 902-1 in FIG. 9) at the maximum coding rate (e.g., ‘r’ in FIGS. 5, 6) that is selected (at 1008). In aspects, the UE 1002 may be configured to transmit a first PUCCH with the information 1010 in the PUCCH resource (e.g., 502, 504, 506 in FIG. 5; 612 in FIG. 6; 808 in FIG. 8; 914-2, 914-3, 918 in FIG. 9) of the FD slot (e.g., 902, 902-1 in FIG. 9) with the first coding rate based on the first maximum coding rate (e.g., ‘r’ in FIGS. 5, 6).

At 1506, the UE transmits a second PUCCH in the PUCCH resource of an HD slot with a second coding rate based on the second maximum coding rate. As an example, the transmission may be performed by one or more of the component 198, the transceiver(s) 1622, and/or the antenna 1680 in FIG. 16. FIGS. 5, 6, 10 illustrate an example of the UE 1002 performing such a transmission, for a network node (e.g., the base station 1004).

In some aspects, the UE 1002 may be configured to transmit a second PUCCH in the PUCCH resource of an HD slot with the a second maximum coding rate (e.g., ‘r’ for HD in FIGS. 5, 6) that is higher than the first maximum coding rate (e.g., ‘r’ in FIGS. 5, 6). The code rate configuration 1006 may also indicate at least the second maximum coding rate (e.g., ‘r’ for HD in FIGS. 5, 6) for HD slots associated with HD UL transmission of second information via the PUCCH resource (e.g., 502, 504, 506 in FIG. 5; 612 in FIG. 6; 808 in FIG. 8; 914-2, 914-3, 918 in FIG. 9).

FIG. 16 is a diagram 1600 illustrating an example of a hardware implementation for an apparatus 1604. The apparatus 1604 may be a UE, a component of a UE, or may implement UE functionality. In some aspects, the apparatus 1604 may include at least one cellular baseband processor 1624 (which may also be referred to as a modem or processor circuitry) coupled to one or more transceivers 1622 (e.g., cellular RF transceiver). The cellular baseband processor 1624 may include at least one on-chip memory 1624′ (or memory circuitry). In some aspects, the apparatus 1604 may further include one or more subscriber identity modules (SIM) cards 1620 and at least one application processor 1606 (or processor circuitry) coupled to a secure digital (SD) card 1608 and a screen 1610. The application processor 1606 may include at least one on-chip memory 1606′ (or memory circuitry). In some aspects, the apparatus 1604 may further include a Bluetooth module 1612, a WLAN module 1614, an SPS module 1616 (e.g., GNSS module), one or more sensor modules 1618 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1626, a power supply 1630, and/or a camera 1632. The Bluetooth module 1612, the WLAN module 1614, and the SPS module 1616 may include an on-chip transceiver (TRX) (or in some cases, just a receiver (RX)). The Bluetooth module 1612, the WLAN module 1614, and the SPS module 1616 may include their own dedicated antennas and/or utilize the antennas 1680 for communication. The cellular baseband processor 1624 communicates through the transceiver(s) 1622 via one or more antennas 1680 with the UE 104 and/or with an RU associated with a network entity 1602. The cellular baseband processor 1624 and the application processor 1606 may each include a computer-readable medium/memory 1624′, 1606′, respectively. The additional memory modules 1626 may also be considered a computer-readable medium/memory. Each computer-readable medium/memory 1624′, 1606′, 1626 may be non-transitory. The cellular baseband processor 1624 and the application processor 1606 are each responsible for general processing, including the execution of software stored on the computer-readable medium/memory. The software, when executed by the cellular baseband processor 1624/application processor 1606, causes the cellular baseband processor 1624/application processor 1606 to perform the various functions described supra. The cellular baseband processor(s) 1624 and the application processor(s) 1606 are configured to perform the various functions described supra based at least in part of the information stored in the memory. That is, the cellular baseband processor(s) 1624 and the application processor(s) 1606 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor 1624/application processor 1606 when executing software. The cellular baseband processor 1624/application processor 1606 may be a component of the UE 350 and may include the at least one memory 360 and/or at least one of the TX processor 368, the RX processor 356, and the controller/processor 359. In one configuration, the apparatus 1604 may be at least one processor chip (modem and/or application) and include just the cellular baseband processor 1624 and/or the application processor 1606, and in another configuration, the apparatus 1604 may be the entire UE (e.g., see UE 350 of FIG. 3) and include the additional modules of the apparatus 1604.

As discussed supra, the component 198 may be configured to select a PUCCH resource in a FD slot, based on a payload size for UCI, for transmission of at least first CSI via the FD slot. The component 198 may be configured to transmit the UCI in the PUCCH resource in the FD slot. The component 198 may be configured to receive a configuration for a set of multiple CSI PUCCH resources, where the UCI includes multiplexed CSI reports, and the PUCCH resource is selected from the set of multiple CSI PUCCH resources. The component 198 may be configured to identify an overlap in time between the first CSI and a second CSI, where the second CSI overlaps with at least one of a downlink or a guard band frequency resources of the FD slot, and to drop transmission of the second CSI based on not having a configuration for multiple CSI PUCCH resources and transmitting the first CSI in the PUCCH resource. The component 198 may be configured to identify an overlap in time between the first CSI and a second CSI, and to drop transmission of the second CSI based on not having a configuration for multiple CSI PUCCH resources and the second CSI having a lower priority than the first CSI. The component 198 may be configured to identify an overlap in time between the first CSI and a second CSI, to compare a sum of the first payload size for the UCI and a second payload size for the first CSI with a resource size of the PUCCH resource, and to drop at least a portion of one of the first CSI and the second CSI based on the sum of the first payload size for the UCI and the second payload size for the first CSI being greater than the resource size of the PUCCH resource. The component 198 may be configured to identify an overlap of an overlapping PUCCH resource with at least one of a downlink (DL) slot or a guard band of the PUCCH, and to adapt an amount of available resources for the PUCCH resource based on a removal of the overlap and a generation of an adapted PUCCH resource, where the removal of the overlap is based on a first number of resource elements (REs) that are non-overlapping with the at least one of a DL slot or the guard band of the PUCCH, and where the generation of the adapted PUCCH resource is based on a second number of resource blocks (RBs) that include the first number of REs, where to transmit the UCI in the PUCCH resource in the FD slot, where the component 198 is configured to transmit the UCI in the adapted PUCCH resource as the PUCCH resource. The component 198 may be configured to receive a code rate configuration that indicates at least a first maximum coding rate for uplink transmission of first information via a PUCCH resource in FD slots. The component 198 may be configured to transmit a first PUCCH in the PUCCH resource of a FD slot with a first coding rate based on the first maximum coding rate. The component 198 may be configured to transmit a second PUCCH in the PUCCH resource of an HD slot with a second coding rate based on the second maximum coding rate, where the code rate configuration also indicates at least a second maximum coding rate for half duplex (HD) slots associated with HD uplink transmission of second information via the PUCCH resource, where the second maximum coding rate is higher than the first maximum coding rate. The component 198 may be further configured to perform any of the aspects described in connection with the flowchart in any of FIGS. 11-14, and/or any of the aspects performed by the UE in any of FIGS. 4A-10. The component 198 may be within the cellular baseband processor 1624, the application processor 1606, or both the cellular baseband processor 1624 and the application processor 1606. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1604 may include a variety of components configured for various functions. In one configuration, the apparatus 1604, and in particular the cellular baseband processor 1624 and/or the application processor 1606, may include means for selecting a PUCCH resource in a FD slot, based on a payload size for UCI, for transmission of at least first CSI via the FD slot. In the configuration, the apparatus 1604, and in particular the cellular baseband processor 1624 and/or the application processor 1606, may include means for transmitting the UCI in the PUCCH resource in the FD slot. In a configuration, the apparatus 1604, and in particular the cellular baseband processor 1624 and/or the application processor 1606, may include means for receiving a configuration for a set of multiple CSI PUCCH resources, where the UCI includes multiplexed CSI reports, and the PUCCH resource is selected from the set of multiple CSI PUCCH resources. In a configuration, the apparatus 1604, and in particular the cellular baseband processor 1624 and/or the application processor 1606, may include means for identifying an overlap in time between the first CSI and second CSI, where the second CSI overlaps with at least one of a downlink or a guard band frequency resources of the FD slot, and for dropping transmission of the second CSI based on not having a configuration for multiple CSI PUCCH resources and transmitting the first CSI in the PUCCH resource. In a configuration, the apparatus 1604, and in particular the cellular baseband processor 1624 and/or the application processor 1606, may include means for identifying an overlap in time between the first CSI and a second CSI, and for dropping transmission of the second CSI based on not having a configuration for multiple CSI PUCCH resources and the second CSI having a lower priority than the first CSI. In a configuration, the apparatus 1604, and in particular the cellular baseband processor 1624 and/or the application processor 1606, may include means for identifying an overlap in time between the first CSI and a second CSI, for comparing a sum of the first payload size for the UCI and a second payload size for the first CSI with a resource size of the PUCCH resource, and for dropping at least a portion of one of the first CSI and the second CSI based on the sum of the first payload size for the UCI and the second payload size for the first CSI being greater than the resource size of the PUCCH resource. In a configuration, the apparatus 1604, and in particular the cellular baseband processor 1624 and/or the application processor 1606, may include means for identifying an overlap of an overlapping PUCCH resource with at least one of a downlink (DL) slot or a guard band of the PUCCH, and for adapting an amount of available resources for the PUCCH resource based on a removal of the overlap and a generation of an adapted PUCCH resource, where the removal of the overlap is based on a first number of resource elements (REs) that are non-overlapping with the at least one of a DL slot or the guard band of the PUCCH, and where the generation of the adapted PUCCH resource is based on a second number of resource blocks (RBs) that include the first number of REs, where the means for transmitting the UCI in the PUCCH resource in the FD slot includes means for transmitting the UCI in the adapted PUCCH resource as the PUCCH resource. In a configuration, the apparatus 1604, and in particular the cellular baseband processor 1624 and/or the application processor 1606, may include means for receiving a code rate configuration that indicates at least a first maximum coding rate for uplink transmission of first information via a PUCCH resource in FD slots. In a configuration, the apparatus 1604, and in particular the cellular baseband processor 1624 and/or the application processor 1606, may include means for transmitting a first PUCCH in the PUCCH resource of a FD slot with a first coding rate based on the first maximum coding rate. In a configuration, the apparatus 1604, and in particular the cellular baseband processor 1624 and/or the application processor 1606, may include means for transmitting a second PUCCH in the PUCCH resource of an HD slot with a second coding rate based on the second maximum coding rate, where the code rate configuration also indicates at least a second maximum coding rate for half duplex (HD) slots associated with HD uplink transmission of second information via the PUCCH resource, where the second maximum coding rate is higher than the first maximum coding rate. The means may be the component 198 of the apparatus 1604 configured to perform the functions recited by the means. As described supra, the apparatus 1604 may include the TX processor 368, the RX processor 356, and the controller/processor 359. As such, in one configuration, the means may be the TX processor 368, the RX processor 356, and/or the controller/processor 359 configured to perform the functions recited by the means.

FIG. 17 is a diagram 1700 illustrating an example of a hardware implementation for a network entity 1702. The network entity 1702 may be a BS, a component of a BS, or may implement BS functionality. The network entity 1702 may include at least one of a CU 1710, a DU 1730, or an RU 1740. For example, depending on the layer functionality handled by the component 199, the network entity 1702 may include the CU 1710; both the CU 1710 and the DU 1730; each of the CU 1710, the DU 1730, and the RU 1740; the DU 1730; both the DU 1730 and the RU 1740; or the RU 1740. The CU 1710 may include at least one CU processor 1712 (or processor circuitry). The CU processor 1712 may include at least one on-chip memory 1712′ (or memory circuitry). In some aspects, the CU 1710 may further include additional memory modules 1714 and a communications interface 1718. The CU 1710 communicates with the DU 1730 through a midhaul link, such as an F1 interface. The DU 1730 may include at least one DU processor 1732 (or processor circuitry). The DU processor 1732 may include at least one on-chip memory 1732′ (or memory circuitry). In some aspects, the DU 1730 may further include additional memory modules 1734 and a communications interface 1738. The DU 1730 communicates with the RU 1740 through a fronthaul link. The RU 1740 may include at least one RU processor 1742 (or processor circuitry). The RU processor 1742 may include at least one on-chip memory 1742′ (or memory circuitry). In some aspects, the RU 1740 may further include additional memory modules 1744, one or more transceivers 1746, antennas 1780, and a communications interface 1748. The RU 1740 communicates with the UE 104. The on-chip memory 1712′, 1732′, 1742′ and the additional memory modules 1714, 1734, 1744 may each be considered a computer-readable medium/memory. Each computer-readable medium/memory may be non-transitory. Each of the processors 1712, 1732, 1742 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to configure a set of multiple CSI PUCCH resources for a user equipment. The component 199 may also be configured to indicate that at least one slot will be a FD slot. The component 199 may be further configured to receive, in the FD slot, UCI including multiplexed CSI reports in at least a portion of a PUCCH resource from the set of multiple CSI PUCCH resources. The component 199 may be further configured to perform any of the aspects described in connection with the flowchart in any of FIGS. 11-14, and/or any of the aspects performed by the base station in any of FIGS. 4A-10. The component 199 may be within one or more processors of one or more of the CU 1710, DU 1730, and the RU 1740. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1702 may include a variety of components configured for various functions. In one configuration, the network entity 1702 may include means for configuring a set of multiple CSI PUCCH resources for a user equipment. In the configuration, the network entity 1702 may include means for indicating that at least one slot will be a FD slot. In the configuration, the network entity 1702 may include means for receiving, in the FD slot, UCI including multiplexed CSI reports in at least a portion of a PUCCH resource from the set of multiple CSI PUCCH resources. The means may be the component 199 of the network entity 1702 configured to perform the functions recited by the means. As described supra, the network entity 1702 may include the TX processor 316, the RX processor 370, and the controller/processor 375. As such, in one configuration, the means may be the TX processor 316, the RX processor 370, and/or the controller/processor 375 configured to perform the functions recited by the means.

Wireless communication networks, such as a 5G NR network, may enable multiplexing of information for transmissions. For instance, different instances of UCI may be multiplexed for an UL transmission from a UE, e.g., to a base station. As examples, a hybrid automatic repeat request (HARQ) acknowledgment (ACK) (HARQ-ACK) and/or a scheduling request (SR) may be multiplexed with one or more instances of channel state information (CSI), one or more instances of CSI may be multiplexed with each other, and/or the like, for reporting by a UE in a physical uplink control channel (PUCCH) resource for an UL transmission.

However, unlike half duplex (HD) operations, in sub-band full duplex (SBFD) operations, a PUCCH resource for a transmission in an SBFD slot may overlap with a guard band or a DL resource(s) in the slot. That is, UL sub-bands may have less bandwidth in which to accommodate resources in full duplex (FD) operations than in HD operations. Overlapping PUCCH resources under such a conflict in a FD mode may not be available for multiplexing UCI and/or multi-CSI instances. While later available PUCCH resources may be present, such resources may also overlap guard bands and/or DL resources, and even if later PUCCH resources are capable of transmitting multiplexed UCI and multi-CSI instances, this may impact timing, or even ultimate transmission, of UCI/CSI.

Various aspects herein relate to UCI and multi-CSI multiplexing on PUCCH for SBFD. For instance, aspects may relate to CSI reporting when multiple CSI PUCCH resources are unconfigured, PUCCH resource selection for Multi-CSI reporting, enhanced PUCCH resource configurations for SBFD, and/or the like. In some examples, a UE may select a PUCCH resource in a FD slot, based on a UCI payload size, for transmission of CSI(s) via the FD slot, and transmit the UCI in the PUCCH resource in the FD slot. In some examples, a base station may configure a set of multiple CSI PUCCH resources for a UE, indicate that at least one slot will be a FD slot, and receive, in the FD slot, UCI including multiplexed CSI reports in at least a portion of a PUCCH resource from the set of multiple CSI PUCCH resources.

In some examples, by configuring PUCCH resources for FD slots, the described techniques can be used to select a particular PUCCH resource for multiplexing UCI/multi-CSI. In some examples, by selecting a PUCCH resource from an available, non-overlapping FDRA, the described techniques can be used to provide additional transmission options for multiplexing UCI/multi-CSI. In some examples, by dropping overlapping reports or PUCCH resources, the described techniques can be used to adapt and/or prioritize provide UCI/multi-CSI for multiplexing in available resources. In some examples, by adapting overlapping PUCCH resources, the described techniques can be used to provide UCI/multi-CSI for multiplexing via available, non-overlapping resource elements. In some examples, by configuring a maximum coding rate, the described techniques can be used to maintain reliability of PUCCH resources in different slot types (e.g., HD/FD).

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. If a first apparatus receives data from or transmits data to a second apparatus, the data may be received/transmitted directly between the first and second apparatuses, or indirectly between the first and second apparatuses through a set of apparatuses. A device configured to “output” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE, including: selecting a PUCCH resource in a FD slot, based on a payload size for UCI, for transmission of at least first CSI via the FD slot; and transmitting the UCI in the PUCCH resource in the FD slot.

Aspect 2 is the method of aspect 1, further including: receiving a configuration for a set of multiple CSI PUCCH resources, where the UCI includes multiplexed CSI reports, and the PUCCH resource is based on a selection from the set of multiple CSI PUCCH resources.

Aspect 3 is the method of aspect 2, where the configuration is comprised in a PUCCH configuration for SBFD communication.

Aspect 4 is the method of aspect 2, where the configuration is comprised in a PUCCH configuration for full-duplex and half-duplex communication, the configuration including a first configuration of resources associated with HD operation and a second configuration of resources associated with FD operation, where selecting the PUCCH resource includes: selecting a set of PUCCH resources based on the FD slot having a FD slot type associated with the FD operation.

Aspect 5 is the method of aspect 2, where the configuration includes a first subset of resources associated with FD operation and a second subset of resources associated with HD operation, where the PUCCH resource is selected from the first subset of resources associated with the FD operation.

Aspect 6 is the method of aspect 2, where selecting the PUCCH resource includes selecting the PUCCH resource from the set of multiple CSI PUCCH resources after removal of frequency resources from an FDRA that overlap with downlink or guard band frequency resources in the FD slot.

Aspect 7 is the method of aspect 2, where selecting the PUCCH resource includes selecting the PUCCH resource from the set of multiple CSI PUCCH resources that are non-overlapping with downlink or guard band frequency resources in the FD slot.

Aspect 8 is the method of any of aspects 1 to 7, where the UCI further includes at least one of a HARQ-ACK information for a dynamic PDSCH, an (SPS PDSCH, or an SR.

Aspect 9 is the method of any of aspects 1 to 8, further including: identifying an overlap in time between the first CSI and second CSI, where the second CSI overlaps with at least one of a downlink or a guard band frequency resources of the FD slot; and dropping transmission of the second CSI based on not having a configuration for multiple CSI PUCCH resources and transmitting the first CSI in the PUCCH resource.

Aspect 10 is the method of any of aspects 1 to 8, further including: identifying an overlap in time between the first CSI and a second CSI; and dropping transmission of the second CSI based on not having a configuration for multiple CSI PUCCH resources and the second CSI having a lower priority than the first CSI.

Aspect 11 is the method of any of aspects 1 to 8, further including: identifying an overlap in time between the first CSI and a second CSI; comparing a sum of a first payload size for the UCI and a second payload size for the first CSI with a resource size of the PUCCH resource; and dropping at least a portion of one of the first CSI and the second CSI based on the sum of the first payload size for the UCI and the second payload size for the first CSI being greater than the resource size of the PUCCH resource.

Aspect 12 is the method of any of aspects 1 to 8, further including: identifying an overlap of an overlapping PUCCH resource with at least one of a downlink (DL) slot or a guard band of the PUCCH; and adapting an amount of available resources for the PUCCH resource based on a removal of the overlap and a generation of an adapted PUCCH resource, where the removal of the overlap is based on a first number of REs that are non-overlapping with the at least one of a DL slot or the guard band of a PUCCH, and where the generation of the adapted PUCCH resource is based on a second number of RBs that include the first number of REs; where transmitting the UCI in the PUCCH resource in the FD slot includes transmitting the UCI in the adapted PUCCH resource as the PUCCH resource.

Aspect 13 is a method of wireless communication at a network node, including: configuring a set of multiple CSI PUCCH resources for a UE; indicating that at least one slot will be an FD slot; and receiving, in the FD slot, UCI including multiplexed CSI reports in at least a portion of a PUCCH resource from the set of multiple CSI PUCCH resources.

Aspect 14 is the method of aspect 13, where the set of multiple CSI PUCCH resources includes a first PUCCH configuration associated with HD operation and a second PUCCH configuration associated with FD operation.

Aspect 15 is the method of aspect 13, where the set of multiple CSI PUCCH resources includes a FD subset of PUCCH resources associated with FD operation and an HD subset of PUCCH resources associated with HD operation, where the PUCCH resource corresponds to a resource index associated with the FD operation.

Aspect 16 is the method of aspect 13, where the UCI is comprised in the PUCCH resource from the set of multiple CSI PUCCH resources after removal of frequency resources from an FDRA that overlap with downlink resources or guard band frequency resources of the FD slot.

Aspect 17 is the method of aspect 13, where the PUCCH resource is one of the set of multiple CSI PUCCH resources that is non-overlapping in frequency with downlink or guard band frequency resources.

Aspect 18 is the method of any of aspects 13 to 17, where the UCI further includes at least one of a HARQ-ACK information for a dynamic PDSCH, an SPS PDSCH, or an SR.

Aspect 19 is the method of any of aspects 13 to 18, where the FD slot is an SBFD slot.

Aspect 20 is a method of wireless communication at a UE, including: receiving a code rate configuration that indicates at least a first maximum coding rate for uplink transmission of first information via a PUCCH resource in FD slots; and transmitting a first PUCCH in the PUCCH resource of a FD slot with a first coding rate based on the first maximum coding rate.

Aspect 21 is the method of aspect 20, where the code rate configuration also indicates at least a second maximum coding rate for HD slots associated with HD uplink transmission of second information via the PUCCH resource, where the second maximum coding rate is higher than the first maximum coding rate, the method further including: transmitting a second PUCCH in the PUCCH resource of an HD slot with a second coding rate based on the second maximum coding rate.

Aspect 22 is the method of any of aspects 20 and 21, where the first FD slot is an SBFD slot and the PUCCH resource is an uplink sub-band of the SBFD slot.

Aspect 23 is the method of any of aspects 20 and 22, where receiving the code rate configuration includes receiving the code rate configuration from a network node as a portion of a common configuration for the FD slots and HD slots.

Aspect 24 is an apparatus for wireless communication at a UE, comprising means for performing each step in the method of any of aspects 1 to 12.

Aspect 25 is a computer-readable medium (e.g., a non-transitory computer-readable medium) storing computer executable code at a UE, the code when executed by at least one processor causes the causes the UE to perform the method of any of aspects 1 to 12.

Aspect 26 is an apparatus for wireless communication at a UE. The apparatus comprises at least one memory; and at least one processor coupled to the at least one memory and, based at least in part on information stored in the at least one memory, the at least one processor is configured to cause the UE to implement any of aspects 1 to 12.

Aspect 27 is the apparatus of aspect 26, further including at least one of a transceiver or an antenna coupled to the at least one processor.

Aspect 28 is an apparatus for wireless communication at a network node, comprising means for performing each step in the method of any of aspects 13 to 19.

Aspect 29 is a computer-readable medium (e.g., a non-transitory computer-readable medium) storing computer executable code at a network node, the code when executed by at least one processor causes the network node to perform the method of any of aspects 13 to 19.

Aspect 30 is an apparatus for wireless communication at a network node. The apparatus comprises at least one memory; and at least one processor coupled to the at least one memory and, based at least in part on information stored in the at least one memory, the at least one processor is configured to cause the network node to implement any of aspects 13 to 19.

Aspect 31 is the apparatus of aspect 30, further including at least one of a transceiver or an antenna coupled to the at least one processor.

Aspect 32 is an apparatus for wireless communication at a UE, comprising means for performing each step in the method of any of aspects 20 to 23.

Aspect 33 is a computer-readable medium (e.g., a non-transitory computer-readable medium) storing computer executable code at a UE, the code when executed by at least one processor causes the UE to perform the method of any of aspects 20 to 23.

Aspect 34 is an apparatus for wireless communication at a UE. The apparatus comprises at least one memory; and at least one processor coupled to the at least one memory and, based at least in part on information stored in the at least one memory, the at least one processor is configured to cause the UE to implement any of aspects 20 to 23.

Aspect 35 is the apparatus of aspect 34, further including at least one of a transceiver or an antenna coupled to the at least one processor.

What is claimed is:

1. An apparatus for wireless communication at a user equipment (UE), comprising:
at least one memory; and
at least one processor coupled to the at least one memory and, based at least in part on information stored in the at least one memory, the at least one processor, individually or in any combination, is configured to cause the UE to:
select a physical uplink control channel (PUCCH) resource in a full duplex (FD) slot, based on a payload size for uplink control information (UCI), for transmission of at least first channel state information (CSI) via the FD slot; and
transmit the UCI in the PUCCH resource in the FD slot.

2. The apparatus of claim 1, wherein the at least one processor, individually or in any combination, is further configured to cause the UE to:
receive a configuration for a set of multiple CSI PUCCH resources, wherein the UCI includes multiplexed CSI reports, and the PUCCH resource is based on a selection from the set of multiple CSI PUCCH resources.

3. The apparatus of claim 2, wherein the configuration is comprised in a PUCCH configuration for sub-band full-duplex (SBFD) communication.

4. The apparatus of claim 2, wherein the configuration is comprised in a PUCCH configuration for full-duplex and half-duplex communication, the configuration including a first configuration of resources associated with half duplex (HD) operation and a second configuration of resources associated with FD operation, wherein to select the PUCCH resource, the at least one processor, individually or in any combination, is configured to cause the UE to:
select a set of PUCCH resources based on the FD slot having a FD slot type associated with the FD operation.

5. The apparatus of claim 2, wherein the configuration includes a first subset of resources associated with FD operation and a second subset of resources associated with HD operation, where the PUCCH resource is selected from the first subset of resources associated with the FD operation.

6. The apparatus of claim 2, wherein to select the PUCCH resource, the at least one processor, individually or in any combination, is further configured to cause the UE to select the PUCCH resource from the set of multiple CSI PUCCH resources after removal of frequency resources from a frequency domain resource allocation (FDRA) that overlap with downlink or guard band frequency resources in the FD slot.

7. The apparatus of claim 2, wherein to select the PUCCH resource, the at least one processor, individually or in any combination, is further configured to cause the UE to select the PUCCH resource from the set of multiple CSI PUCCH resources that are non-overlapping with downlink or guard band frequency resources in the FD slot.

8. The apparatus of claim 2, wherein the UCI further includes at least one of a hybrid automatic repeat request (HARQ) acknowledgment (ACK) (HARQ-ACK) information for a dynamic physical downlink shared channel (PDSCH), a semi-persistent (SPS) PDSCH, or a scheduling request (SR).

9. The apparatus of claim 1, wherein the at least one processor, individually or in any combination, is further configured to cause the UE to:
identify an overlap in time between the first CSI and a second CSI, wherein the second CSI overlaps with at least one of a downlink or a guard band frequency resources of the FD slot; and
drop transmission of the second CSI based on not having a configuration for multiple CSI PUCCH resources and transmitting the first CSI in the PUCCH resource.

10. The apparatus of claim 1, wherein the at least one processor, individually or in any combination, is further configured to cause the UE to:
identify an overlap in time between the first CSI and a second CSI; and
drop transmission of the second CSI based on not having a configuration for multiple CSI PUCCH resources and the second CSI having a lower priority than the first CSI.

11. The apparatus of claim 1, wherein the at least one processor, individually or in any combination, is further configured to cause the UE to:
identify an overlap in time between the first CSI and a second CSI;
compare a sum of a first payload size for the UCI and a second payload size for the first CSI with a resource size of the PUCCH resource; and
drop at least a portion of one of the first CSI and the second CSI based on the sum of the first payload size for the UCI and the second payload size for the first CSI being greater than the resource size of the PUCCH resource.

12. The apparatus of claim 1, wherein the at least one processor, individually or in any combination, is further configured to cause the UE to:
identify an overlap of an overlapping PUCCH resource with at least one of a downlink (DL) slot or a guard band of a PUCCH; and
adapt an amount of available resources for the PUCCH resource based on a removal of the overlap and a generation of an adapted PUCCH resource, wherein the removal of the overlap is based on a first number of resource elements (REs) that are non-overlapping with the at least one of a DL slot or the guard band of the PUCCH, and wherein the generation of the adapted PUCCH resource is based on a second number of resource blocks (RBs) that include the first number of REs;
wherein to transmit the UCI in the PUCCH resource in the FD slot, the at least one processor, individually or in any combination, is configured to cause the UE to transmit the UCI in the adapted PUCCH resource as the PUCCH resource.

13. An apparatus for wireless communication at a network node, comprising:
at least one memory; and
at least one processor coupled to the at least one memory and, based at least in part on information stored in the at least one memory, the at least one processor, individually or in any combination, is configured to network node to:
configure a set of multiple channel state information (CSI) physical uplink control channel (PUCCH) resources for a user equipment (UE);
indicate that at least one slot will be a full duplex (FD) slot; and
receive, in the FD slot, uplink control information (UCI) including multiplexed CSI reports in at least a portion of a PUCCH resource from the set of multiple CSI PUCCH resources.

14. The apparatus of claim 13, wherein the set of multiple CSI PUCCH resources includes a first PUCCH configuration associated with half duplex (HD) operation and a second PUCCH configuration associated with FD operation.

15. The apparatus of claim 13, wherein the set of multiple CSI PUCCH resources includes a FD subset of PUCCH resources associated with FD operation and a half duplex (HD) subset of PUCCH resources associated with HD operation, wherein the PUCCH resource corresponds to a resource index associated with the FD operation.

16. The apparatus of claim 13, wherein the UCI is comprised in the PUCCH resource from the set of multiple CSI PUCCH resources after removal of frequency resources from a frequency domain resource allocation (FDRA) that overlap with downlink or guard band frequency resources of the FD slot.

17. The apparatus of claim 13, wherein the PUCCH resource is one of the set of multiple CSI PUCCH resources that is non-overlapping in frequency with downlink or guard band frequency resources.

18. The apparatus of claim 13, wherein the UCI further includes at least one of a hybrid automatic repeat request (HARQ) acknowledgment (ACK) (HARQ-ACK) information for a dynamic physical downlink shared channel (PDSCH), a semi-persistent (SPS) PDSCH, or a scheduling request (SR).

19. The apparatus of claim 13, wherein the FD slot is a sub-band FD (SBFD) slot.

20. An apparatus for wireless communication at a user equipment (UE), comprising:
at least one memory; and
at least one processor coupled to the at least one memory and, based at least in part on information stored in the at least one memory, the at least one processor, individually or in any combination, is configured to cause the UE to:
receive a code rate configuration that indicates at least a first maximum coding rate for uplink transmission of first information via a physical uplink control channel (PUCCH) resource in full duplex (FD) slots; and
transmit a first PUCCH in the PUCCH resource of a FD slot with a first coding rate based on the first maximum coding rate.

21. The apparatus of claim 20, wherein the code rate configuration also indicates at least a second maximum coding rate for half duplex (HD) slots associated with HD uplink transmission of second information via the PUCCH resource, wherein the second maximum coding rate is higher than the first maximum coding rate, and wherein the at least one processor, individually or in any combination, is further configured to cause the UE to:
transmit a second PUCCH in the PUCCH resource of an HD slot with a second coding rate based on the second maximum coding rate.

22. The apparatus of claim 20, wherein the first FD slot is a sub-band FD (SBFD) slot and the PUCCH resource is an uplink sub-band of the SBFD slot.

23. The apparatus of claim 20, wherein to receive the code rate configuration, wherein the at least one processor, individually or in any combination, is configured to cause the UE to receive the code rate configuration from a network node as a portion of a common configuration for the FD slots and half duplex (HD) slots.

24. A method of wireless communication at a user equipment (UE), comprising:
selecting a physical uplink control channel (PUCCH) resource in a full duplex (FD) slot, based on a payload size for uplink control information (UCI), for transmission of at least first channel state information (CSI) via the FD slot; and
transmitting the UCI in the PUCCH resource in the FD slot.

25. The method of claim 24, further comprising:
receiving a configuration for a set of multiple CSI PUCCH resources, wherein the UCI includes multiplexed CSI reports, and the PUCCH resource is selected from the set of multiple CSI PUCCH resources.

26. The method of claim 25, wherein the configuration is comprised in a PUCCH configuration for sub-band full-duplex (SBFD) communication.

27. The method of claim 25, wherein the configuration is comprised in a PUCCH configuration for full-duplex and half-duplex communication, the configuration including a first configuration of resources associated with half duplex (HD) operation and a second configuration of resources associated with FD operation, wherein selecting the PUCCH resource includes selecting a set of PUCCH resources based on the FD slot having a FD slot type associated with the FD operation;
wherein the configuration includes a first subset of resources associated with the FD operation and a second subset of resources associated with HD operation, where the PUCCH resource is selected from the first subset of resources associated with the FD operation;
wherein selecting the PUCCH resource includes selecting the PUCCH resource from the set of multiple CSI PUCCH resources after removal of frequency resources from a frequency domain resource allocation (FDRA) that overlap with downlink resources or guard band frequency resources in the FD slot;
wherein selecting the PUCCH resource includes selecting the PUCCH resource from the set of multiple CSI PUCCH resources that are non-overlapping with the downlink resources or the guard band frequency resources in the FD slot; or
wherein the UCI further includes at least one of a hybrid automatic repeat request (HARQ) acknowledgment (ACK) (HARQ-ACK) information for a dynamic physical downlink shared channel (PDSCH), a semi-persistent (SPS) PDSCH, or a scheduling request (SR).

28. The method of claim 24, further comprising:
identifying an overlap in time between the first CSI and second CSI, wherein the second CSI overlaps with at least one of a downlink or a guard band frequency resources of the FD slot; and
dropping transmission of the second CSI based on not having a configuration for multiple CSI PUCCH resources and transmitting the first CSI in the PUCCH resource.

29. The method of claim 24, further comprising:
identifying an overlap in time between the first CSI and a second CSI; and
performing at least one of:
dropping transmission of the second CSI based on not having a configuration for multiple CSI PUCCH resources and the second CSI having a lower priority than the first CSI; or
comparing a sum of a first payload size for the UCI and a second payload size for the first CSI with a resource size of the PUCCH resource, and
dropping at least a portion of one of the first CSI and the second CSI based on the sum of the first payload size for the UCI and the second payload size for the first CSI being greater than the resource size of the PUCCH resource.

30. The method of claim 24, further comprising:
identifying an overlap of an overlapping PUCCH resource with at least one of a downlink (DL) slot or a guard band of a PUCCH; and
adapting an amount of available resources for the PUCCH resource based on a removal of the overlap and a generation of an adapted PUCCH resource, wherein the removal of the overlap is based on a first number of resource elements (REs) that are non-overlapping with the at least one of a DL slot or the guard band of the PUCCH, and wherein the generation of the adapted PUCCH resource is based on a second number of resource blocks (RBs) that include the first number of REs;
wherein transmitting the UCI in the PUCCH resource in the FD slot includes transmitting the UCI in the adapted PUCCH resource as the PUCCH resource.
